(19) United States
(12) Patent Application Publication
(10) Pub. No.: US 2025/0365202 A1
(43) Pub. Date: Nov. 27, 2025

(54) SERVICE SLICE COORDINATION FOR EDGE DEPLOYMENTS

(71) Applicant: CONVIDA WIRELESS, LLC, Wilmington, DE (US)

(72) Inventors: Catalina MLADIN, Hatboro, PA (US); Quang LY, North Wales, PA (US); Lu LIU, Conshohocken, PA (US); Dale SEED, Allentown, PA (US)

(21) Appl. No.: 18/873,784

(22) PCT Filed: Jun. 15, 2023
(86) PCT No.: PCT/US2023/068509

§ 371 Date: Dec. 11, 2024

Related U.S. Application Data
(60) Provisional application No. 63/352,288, filed on Jun. 15, 2022.

(51) Int. Cl. H04L 41/0895; H04L 41/5054

(52) U.S. Cl. CPC H04L 41/0895; H04L 41/5054

(57) ABSTRACT

Methods, systems, and devices may assist in providing functionality to coordinate network or service slices supporting a group of services.

### CROSS-REFERENCE TO RELATED APPLICATIONS

This application claims the benefit of U.S. Provisional Patent Application No. 63/352,288, filed on Jun. 15, 2022, entitled “Service Slice Coordination for Edge Deployments,” the contents of which are hereby incorporated by reference herein.

### BACKGROUND

Service Enabler Architecture Layer for Verticals (SEAL) is the service enabler architecture layer common to vertical applications deployed over 3GPP systems. Hence SEAL provides a horizontal layer in which common services are made available to the vertical application layer.

This background information is provided to reveal information believed by the applicant to be of possible relevance. No admission is necessarily intended, nor should be construed, that any of the preceding information constitutes prior art.

### SUMMARY

Disclosed herein are methods, systems, and devices that may assist in providing functionality to coordinate network or service slices supporting a group of services. In an example, a first network application server (or function, SCF) may effectuate operations comprising determining, based on pre-provisioned information, or based on one or more messages from a first apparatus a first configuration of a service slice in the service layer; determining, based on pre-provisioned information, or based on one or more messages from a second apparatus a second configuration of a network slice in the 3GPP network; receiving one or more messages comprising requirements for one or more of the services from the group of services; determining based on the first configuration of a service slice, the second configuration of a network slice and the received service requirements a mapping between the service slice configuration and the network slice configuration; and triggering management operations based on the derived mapping in the service layer, the application layer, or the 3GPP network.

The first apparatus may be realized as one or more application servers or one or more network functions. The second apparatus may be realized as one or more application servers or one or more network functions. The messages may comprise requirements may be received from one or more mobile user devices, one or more application servers, or one or more network functions. The first network application server (or function, SCF) may determine based on received service requirements to update the service slice configuration, the network slice configuration, or the mapping. The first network application server (or function, SCF) may trigger management operations to implement the slice configuration update determined.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 illustrates an exemplary service enabler architecture layer for Verticals (SEAL);

FIG. 2 illustrates an exemplary NSCE Architecture;

FIG. 3 illustrates exemplary business relationships involved in edge computing;

FIG. 4 illustrates exemplary service slices and network slices;

FIG. 5 illustrates exemplary direct and indirect management operations request/trigger;

FIG. 6 illustrates exemplary direct and indirect adaption operations request/trigger;

FIG. 7 illustrates exemplary generic coordinated slice adaption flow;

FIG. 8 illustrates exemplary SA6 edge computing overview;

FIG. 9 illustrates exemplary slice configuration function (SCF) mapping to an embodiment of an SA6 Edge deployment;

FIG. 10 illustrates exemplary SA6 SCF coordinated slice adaption flow for an edge deployment;

FIG. 11 illustrates exemplary SA6 SCF flow for Edge Hosting Environment (EHE) instantiation with separate Mobile Network Operators (MNO) MnS and Edge Computing Service Providers (ECSP) management;

FIG. 12 illustrates exemplary SA6 SCF flow for EHE instantiation with MNO Management System (MnS) providing ECSP management;

FIG. 13 shows an example of edge deployment information that may be entered via an ECSP graphical user interface;

FIG. 14 illustrates an exemplary method associated with service slice coordination as disclosed herein;

FIG. 15A illustrates an example communications system;

FIG. 15B illustrates an exemplary system that includes radio access networks (RANs) and core networks;

FIG. 15C illustrates an exemplary system that includes RANs and core networks;

FIG. 15D illustrates an exemplary system that includes RANs and core networks;

FIG. 15E illustrates another example communications system;

FIG. 15F is a block diagram of an example apparatus or device, such as a WTRU; and

FIG. 15G is a block diagram of an exemplary computing system.

### DETAILED DESCRIPTION

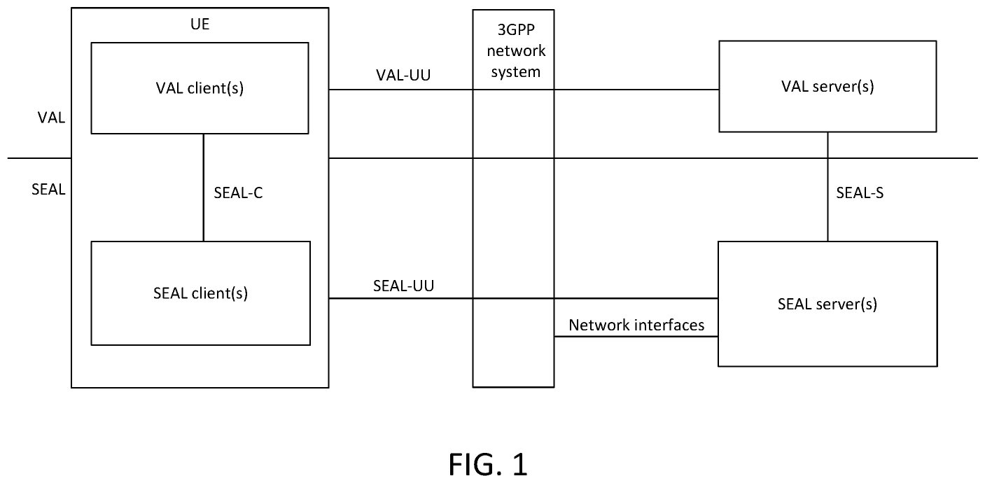

FIG. 1 shows an example of the Service Enabler Architecture Layer for Verticals (SEAL) in the 3GPP SA6 working group. SEAL is the service enabler architecture layer common to vertical applications deployed over 3GPP systems. Hence SEAL provides a horizontal layer in which common services are made available to the vertical application layer. Some of the common services may include 1) location management; 2) group management; 3) configuration management; 4) identity management; 5) key management; or 6) network resource management.

Vertical Application Layer (VAL) client(s) accesses the services offered by SEAL client(s) on the UE, which then transports traffic to SEAL server(s) using the SEAL-UU interface. The SEAL server routes the traffic to the destination VAL server(s) and may communicate with other SEAL server(s), which is not shown in FIG. 1. In addition, the SEAL server(s) has access to network exposure information via network interfaces with the 3GPP network. The SEAL services are access by VAL clients and VAL servers via API exposure of the common functions offered by the SEAL layer to vertical applications. For example, SEAL supports network slice capability management.

A SEAL server may be deployed as part of a PLMN operator domain or a VAL service provider domain. When deployed in a VAL service provider domain, the SEAL server may have connections to multiple PLMN operator domains. The SEAL server connects to the 3GPP network system, and one SEAL server may support multiple VAL servers. The functional model of the SEAL layer may be described as on-network in which communications involve the 3GPP network or off-network in which communications occur between two UEs.

SEAL Network Slice Capability Exposure (NSCE): In Release 18. 3GPP recognized the need for network slice capability exposure enhancements to SEAL that have yet to be realized and that enable trusted third parties to access the network slicing APIs defined and exposed by the 5G core network (CN). Aspects of the study include further exposure of network slice lifecycle management operations to trusted third party application layer enablement to support network slice management and control. Such enablement supports the network slice related operations, such as the mapping or migration of one or more vertical applications to one or more network slices. Also in scope for the study are network slice monitoring and triggering of dynamic network slice lifecycle management operations due to changes in application requirements (e.g., QoS) or a network slice status change.

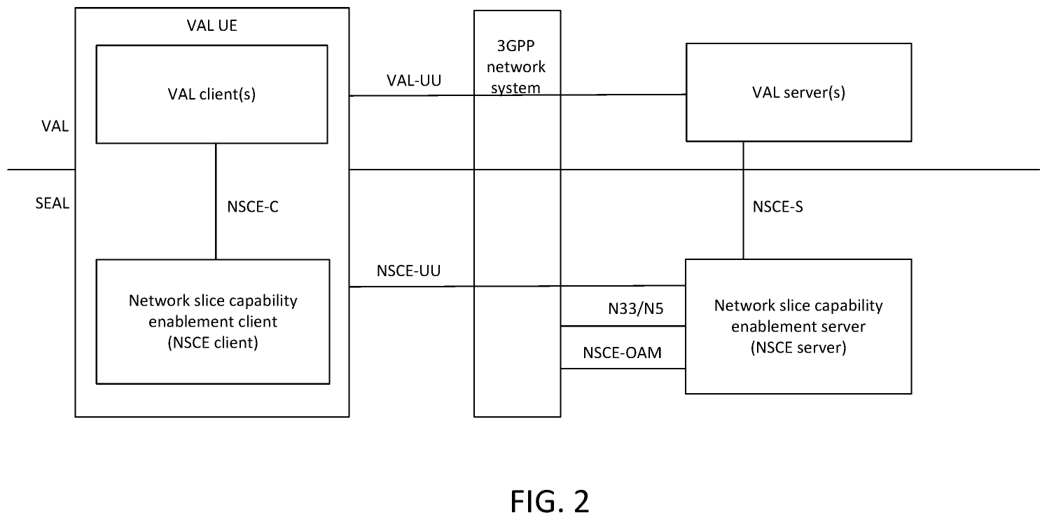

Thus far the Release 18 study has defined the NSCE architecture shown in FIG. 2 which is captured in 3GPP TR 23.700-99. The network slice capability exposure client communicates with the network slice capability exposure server over the NSCE-UU reference point. The network slice capability exposure client provides the support for network slice capability exposure functions to the VAL client(s) over the NSCE-C reference point. The VAL server(s) communicates with the network slice capability exposure server over the NSCE-S reference point. The network slice capability exposure server may communicate with the 5G Core Network functions via NEF (N33) reference point (for interactions with PCF, NSACF, etc.), or by interacting with PCF directly via N5, if permitted. The network slice capability exposure server may interact with the OAM system over the NSCE-OAM reference point (e.g., for network slice lifecycle management operations, fault supervision, etc.).

Note, although not shown in FIG. 2, NSCE client may be realized as functionality integrated within the SEAL client shown in FIG. 1. Likewise, the NSCE server may be realized as functionality integrated within the SEAL server.

NS descriptions for management purposes: The NS Service Profile represents the properties of the network slice related requirements that should be supported by a Network Slice instance in a 5G network. The network slice related requirements apply to a one-to-one relationship between a Network Slice Customer (NSC) and a Network Slice Provider (NSP). A network slice can be tailored based on the specific requirements adhered to an SLA agreed between NSC and NSP. An NSP may add additional requirements not directly derived from SLA's, associated to the NSP internal (e.g., business) goals.

The properties of a NS used by NSPs for management are captured in the NS Service Profile and apply to a one-to-one relationship between NSC and a Network Slice Provider NSP. 3GPP TS 28.541 introduces the NS Service Profile (serviceProfile) available for MNO management of network slices.

3GPP TS 28.312 introduces the concept of intent-driven management and is under development. The methods disclosed so far include “intent” as a way of abstracting some of the NS Service Profile parameters as well as some of the management commands, for exposure to third parties, e.g., NSC/Service Providers.

Network and service slices in the Service Layer: Until Release 18 3GPP has focused slicing work to 5G, based on “network slices” conceptualized as logical networks that achieve specific service requirements. The 3GPP network slices are deployed as optimized solutions/products created by operators within PLMN for specific customers/subscribers. The network capabilities and network characteristics provided by network customized for the application-level services provided by service providers (e.g., edge computing service providers (ECSPs) or application SPs (ASPs)) and enabled by the 5G network.

In current 3GPP networks each NS includes Control Plane and User Plane 5G NFs (e.g., AMF, SMF, or UPF) and UEs that are provided with indicators (NSSAT) of a set of NSs allowed for 5G CN services. Work conducted in ETSI MEC and 3GPP SA5 enable management of NS by network operators.

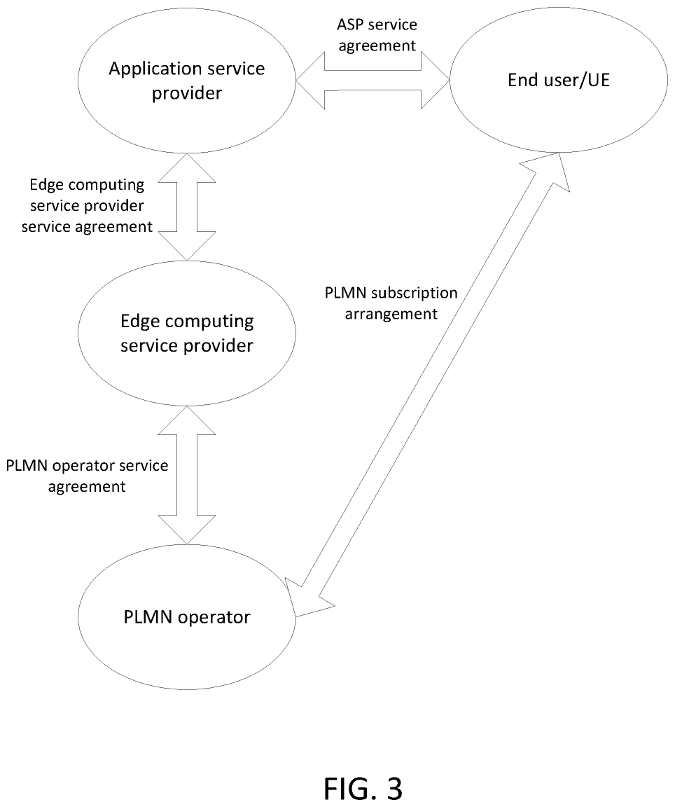

Edge deployments and involved stakeholders: Edge deployments are used in conjunction with 5GS to provide network resources (e.g., access nodes, computing, or storage resources) close to the location where the communication occurs or to the data source. Such deployments may be provided by the network operator, e.g., the MNO or may be provided by edge computing service providers, e.g., ECSPs. FIG. 3 illustrates exemplary business relationships involved in edge computing.

Edge Computing Service Providers (ECSP) will play a key role in the construction of infrastructure used by the Mobile Network Operators (MNO) and by Application Service Providers (ASP). While some edge deployments may be provided by the PLMN operator, (e.g., MNO) others may be provided by third-party edge computing service providers, (e.g., ECSPs).

### Issue Statement

Independent of CN functionality and management, service providers (SPs) such as edge computing service providers (ECSPs) or application services providers (ASPs), among others, may customize the services provided to end-users of mobile devices by employing different server instances, which may include enabler or application servers. The server instances employed for different end-users (or end-user types) may be customized based on the application service requirements of the individual users (e.g., a device of a customer).

3GPP exposes some network slice adaption functionality from the 3GPP CN to authorized service providers, which may be ECSPs. However, the CN network slice (NS) adaptation may be designed to be independent from the adaption and customization of the service environment deployed by service providers.

This may be a shortcoming for deployments in which service providers, such as ECSPs and ASPs, are authorized to perform NS adaption. While the edge deployment configuration logic may take into consideration end-to-end service requirements or the available management functionality, optimizing the underlying 3GPP network independent of the service environment may discard many of the advantages of having common management entities and requirements in the service layer. The service layer is uniquely positioned in the system to provide coordinated adaption of network slices or service capabilities.

Moreover, without employing an edge deployment configuration service that includes network slice or edge hosting environment configuration, each deployment may become dependent on the configuration of the other, effectively creating a race condition. Such scenarios are conventionally avoided by having the Network Operator act as ECSP or through “manual” processes (e.g., establishing SLAs that specify dependencies and sequences between PLMN and EHE configurations). However, as the market expands the need to offer network slices as services to service providers, there is an increased need to allow for such coordinated deployments.

One of the challenges in addressing coordination of deployments is maintaining an appropriate level of abstraction in a potential exposure of network slice management to the service layer. The need for abstraction is at the basis of the intent-driven management being studied. However, intent-driven methods do not allow for coordination with the service slices. They also do not currently provide for an end-to-end coordination of service requirements in the SL and the 3GPP network.

This disclosure addresses methods for service deployments and network slice coordination at the service layer. While the descriptions are provided using edge deployments as a main use case, similar problems exit for service layer deployments which are dependent or correlated with the supporting network slices. Therefore, the disclosed subject matter may apply to non-edge deployments as well.

Disclosed herein is a service slice in the service layer or application layer. Service Slice may be a logical application service environment, such as services with specific service characteristics satisfying various attribute requirements or application deployments for service providers or end users (e.g., one or more devices of a service customer).

Service slices may be used by SPs to enable the delivery of their services to the end user. In general, the characteristics of the services provided by SPs may depend on the performance of the underlying network or of the application servers. The connectivity provided by the 5GS underlying network may rely, in turn, on the characteristics or configuration of the 5GS network slices, which may include CN and access network (AN) network slice subnets. Service slices may include functionality provided by functions or enablers in the service layer, as well as functionality generally included in the application layer. As such, while they may be termed more accurately “service slices” or “application slices,” the term “service slice” is maintained for brevity.

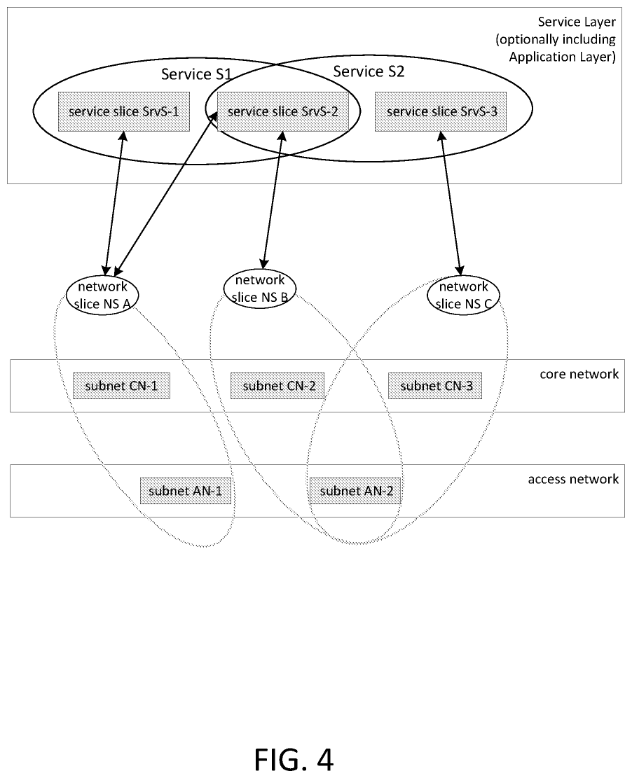

FIG. 4 illustrates an example of the relationship between service slices (SrvS) and 5GS Network Slices (NS). In turn, NSs, from a management perspective, are shown as containing CN and AN NFs.

The AN network function (NF) sets may be configured or managed as network slice subnet AN-1 and network slice subnet AN-2, each containing distinct sets of AN application functions (AFs). The CN NFs may be configured or managed as network slice subnet CN-1, network slice subnet CN-2, and network slice subnet CN-3, in which each may include distinct sets of CN AFs. The network slice subnet AN-2 may be shared between network slice B or network slice C, while network slice subnet AN-1 is dedicated to network slice A.

The mobile network operator (MNO) may provide network slice A, which is a subnet combining subnets CN-1 and AN-1 with an associated service level specification (SLS). In addition, the MNO may offer network slices B or C as shown. The SLS of each network slice (e.g., A, B or C) may partially satisfy the service requirements of services S1 or S2. The service layer deployment may use multiple service layer slices for its own service slice management, as well as for mapping to different network slices. Service S1 may be deployed to be hosted by the service slice SrvS-1 or SrvS-2, while service S2 may be deployed to be hosted by SrvS-2 or SrvS-3. How the information is maintained to enable the mapping of the services to the network slices which may support them is described herein, including in Table 2.

Edge deployments may be uniquely positioned to be implemented using service slices. Edge service slices may be deployed at individual layers or across layers, such as in the following non-exhaustive four examples.

First, edge service slices may be deployed as service slices encompassing an entire service layer, such as a service layer deployed based on 3GPP SA6 specifications, one M2M specifications, or based on proprietary specifications.

Second, edge service slices may be deployed as service slices encompassing a service enablement layer, such as service enabler architecture layer for verticals (SEAL), Factory of the Future application enabler (FAE), V2X application enabler (VAE), unmanned aerial system (UAS) application enabler (UAE), etc. deployments based on 3GPP SA6 specifications (e.g., 3GPP TR 23.745, 3GPP TS 23.764, or 3GPP TS 23.255) or based on proprietary specifications.

Third, edge service slices may be deployed as service slices encompassing a vertical application enablement layer, such as factories of the future (FF), vehicle-to-everything (V2X), or unmanned aerial system (UAS) application-specific layer, vertical application layer (VAL), etc. based on 3GPP SA6 specifications or based on proprietary specifications.

Fourth, edge service slices may be deployed as service slices encompassing entities across application or service layers or sub-layers, such as edge enabling functionality implementing an edge hosting environment (EHE), which may include edge enabler server (EES), edge application server (EAS), or SEAL functionality.

The descriptions herein may assume a service slice as described in the fourth example above, e.g., including the services provided by an EHE deployment with EES, EAS, or SEAL functionality. However, the disclosed descriptions may apply to other types of service slices in edge or in the more general 3GPP contexts, as in an earlier example.

Table 1 shows parameters which may be included in a service slice profile (e.g., SrvS Profile) which may describe the entities included in a service slice (e.g., enablement and application servers), services or service types provided, topology information, KPIs, available metadata and statistics, etc.

The SrvS Profile may provide a comprehensive list of services to be deployed within the service slice and their capabilities, as well as network-dependent capabilities required to provide services at a specified level.

TABLE 1
SrvS Profile

| Information | |
|---|---|
| Element | Description |
| SrvS Profile ID | Identifier of the service slice profile |
| Service slice | List of enablement services (e.g., as EASID) provided by the service |
| enablement services | slice. The list may include additional parameters or characteristics per |
| list | enabler (e.g., SEAL, Edgeapp, V2XApp), e.g., min and max number |
| | of enablement servers of the same type to be deployed, etc. |
| Service slice | List of applications (e.g., as AppID) supported by the service slice. |
| application list | The list may include additional parameters or characteristics per |
| | application, e.g., min and max number of application servers of the |
| | same type to be deployed, application provider IDs, etc. |
| Service slice | Information about the topology of the deployment. For example, a list |
| topology | of enablement servers, value-add servers, application-specific servers |
| information | may be provided, along with information about the connectivity and |
| | functional or hierarchical relationships between them (e.g., list of |
| | associated reference points and related servers). This may include |
| | information about servers instantiated or deactivated, measurements |
| | to be maintained for each server's lifecycle management, etc. |
| Service slice | Provides information on location (e.g., area) serviced by the service |
| location | slice deployment. May be provided as geographical area, RA/TA, or |
| | target DNAI, for example. |
| Service slice | Context and metadata available for different application server types |
| metadata types | or instances, or for the service slice as an aggregate. For example, it |
| | may be specified whether information about the average or min/max |
| | load levels over time, the actual area the connected UEs covered, |
| | measured server availability, response time, etc. may be obtained or |
| | maintained. |
| Enablement services | Context or metadata available for different enabler server types or |
| slice metadata types | instances, or for the enablement services within the slice as an |
| | aggregate. Similar to the above, this parameter characterizes the |
| | enablement services within the slice, rather than the application ones. |
| | For example, average amount of time UEs register for enablement |
| | services per server, service type or slice, etc. |
| Service slice | Statistic information available for the slice deployment. This |
| statistic types | parameter may include information about the UEs receiving services |
| | from the service slice, e.g., number of UEs being provided service as |
| | averages over time, min/max UEs within a period, instantaneous |
| | measurements, etc. The information may also be broken down by |
| | ASs providing the services and may also include average amount of |
| | time providing services per UE, UE locations while receiving |
| | services, UE capabilities, etc. |
| Service slice | Information about the management functionality available at the |
| management types | slice, including SLAs per provider, management APIs, etc. |
| Traffic characteristic | Information about the traffic enabled by the deployment, e.g., data |
| types | rates, QoS, etc. This information may be provided per AS, serviced |
| | UE, etc. |
| CAPIF support | Information about the CAPIF support required for service slice |
| | deployment. |
| Network exposure | Information about the network exposure capabilities needed by the |
| capability | enablement or application services in the service slice. The |
| | information may include additional details about the type and |
| | capabilities of the network exposure APIs used. |
| KPIs and constraints | Service characteristics or constraints of the service slice, provided by |
| | server slice, server type, server instance, etc. This information may be |
| | used to determine corresponding network slices or adaptations |
| | necessary for a network slice to provide the required functionality |
| | together with the service slice. May include one or more of the |
| | component information elements below. |
| >PLMN info | Specifies constraints (e.g., PLMN or S-NSSAI combinations) |
| constraints | required to satisfy service requirements represented by the service |
| | slice |
| >Network slice Type | Specifies whether a standardized network slice type (e.g., eMBB, |
| | URLLC, MIoT, V2X) is required for support of the services within |
| | the service slice. |
| >Required Network | Specifies whether the network slice is required to be simultaneously |
| slice simultaneous | used by a UE together with other network slices and if so, with which |
| Use | other classes of network slices. |
| >Max Number of | Specifies an upper bound for the number of UEs to be supported to |
| UEs | satisfy the requirements of the service slice. An overall UE density |
| | over the coverage area of the slice may also be included. |
| >DL Latency | Specifies the DL packet transmission latency required for reliable |
| | services and is used to determine the necessary characteristics of a |
| | supporting/associated NS |
| >UL Latency | Specifies the UL packet transmission latency required for reliable |
| | services and is used to determine the necessary characteristics of a |
| | supporting/associated NS |
| >DL Throughput | Specifies DL data rate per UE required across the coverage area. The |
| | throughput may also be provided as total for the service, per specific |
| | areas, etc. |
| >UL Throughput | Specifies UL data rate per UE required across the coverage area. The |
| | throughput may also be provided as total for the service, per specific |
| | areas, etc. |
| >DL Max Packet | Specifies maximum DL packet size required to be supported for the |
| Size | services within the service slice. |
| >UL Max Packet | Specifies maximum UL packet size required to be supported for the |
| Size | services within the service slice. |
| >Max DL Data | Specifies an upper bound for DL data volume per UE which may |
| Volume Per UE | support the services within the service slice. |
| >Max UL Data | Specifies an upper bound for DL data volume per UE which may |
| Volume Per UE | support the services within the service slice. |
| >Max Number of | Specifies an upper bound of PDU sessions per UE which may be |
| PDU Sessions Per | ensured by the services within the service slice. |
| UE | |
| >Delay Tolerance | Specifies the requirements to support service delivery flexibility. |
| >Jitter | Specifies maximum jitter which can support the services within the |
| | service slice. |
| >Reliability | Specifies network layer packet transmission reliability necessary to |
| | support the services within the service slice. |
| >UE Mobility Level | Specifies the UE mobility level (e.g., stationary, nomadic) that a |
| and speed | needs to be supported in the network slice for the services within the |
| | service slice. A maximum UE speed to be supported may be |
| | included. |
| >Required NB IoT | Specifies whether NB-IOT support is required in the network slice for |
| support | the services within the service slice. |
| >Required | Specifies whether synchronicity of communication devices support is |
| Synchronicity | required in the network slice for the services within the service slice. |
| | Synchronicity accuracy may also be included. |
| >Required | Specifies whether UE positioning support is required in the network |
| Positioning | slice for the services within the service slice. Parameters such as |
| | accuracy, frequency may also be included. |
| >Required Energy | Specifies whether energy efficiency support is required in the |
| Efficiency | network slice for the services within the service slice. |
| >Required KPI | Specifies whether KPI monitoring is required and a list of KQIs and |
| Monitoring | KPIs necessary to be monitored in the network slice for the services |
| | within the service slice. |
| >Required user | Specifies whether network slice support of capabilities for the |
| management | Service Provider to manage their users or groups of users' network |
| exposure | services and corresponding requirements is required |
| >Required V2X | Specifies whether V2X communication mode is required to be |
| Communications | supported in the network slice to support the services in the service |
| | slice |
| >Required security | Specifies the required network slice security functions and rules to |
| functions | support the services in the service slice. |

An abstracted NS Profile (ANP) may characterize the properties of a NS as they are exposed to a service layer. Various levels of abstraction may be achieved for the purpose of exposure to a service layer which may be controlled by the network slice provider (NSP) or a network slice customer (NSC). The levels of abstraction may depend on the role of the SL (e.g., NSP, NSC) or the particulars of the service level agreement (SLA) for various NSCs.

In conjunction with the ANP, the SL is provided with a set of APIs available for NS configuration lifecycle management, e.g., 3GPP SA5 specified intent-driven management, management system (3GPP SA5) (MnS), life cycle management (3GPP SA5) (LCM), etc.

The disclosed ANP may be implemented with various levels of abstraction, as well as via associated methods per API, such as in the following non-exhaustive three examples.

First, ANP may be implemented with various levels of abstraction as serviceProfile and associated APIs exposed for lifecycle or management purpose by the MNO, or a subset of the parameters or methods within. Second, ANP may be implemented with various levels of abstraction as Intent and associated APIs exposed for management and control of closed-loop automation. Intent can be translated to policies and management tasks used for management; therefore, derived policies and management tasks may be used as an abstracted NS profile instead. Third, ANP may be implemented with various levels of abstraction as policies and management tasks directly provided to the service layer or derived directly from SLA, including rules for translating SL configuration lifecycle into NS configuration lifecycle.

The slice configuration function (SCF) in the service layer provides capabilities for lifecycle management of the service slices (SrvS) configuration in coordination with network slices (NS) configuration.

A dedicated 3GPP cross-domain (e.g., for both CN and AN) management function may be deployed e.g., by MNO. Similarly, a dedicated service domain management function (e.g., using VNF) may be deployed, e.g., by SP.

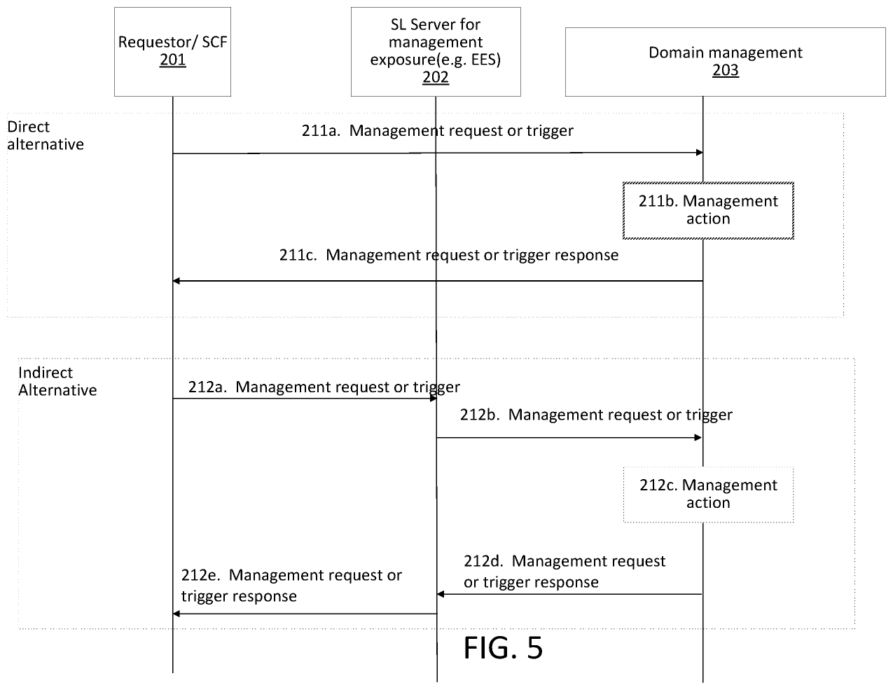

Service layer functionality may be enabled to trigger slice management operations in domain via third-party APIs. Such triggers and their outcomes are referred to as management operations. An example of management operation is instantiation of a new entity, e.g., NF in the CN or AS in the service layer. FIG. 5 shows direct and indirect alternatives for requesting or triggering management operation (in service or network domains) from a requestor in the service layer. FIG. 5 may include requester 201, SL server 202 for management (e.g., EES), or domain management node 203. Example domain management node 203 may include ASP, SP, ESP for service domain; MNO, NSP, or NSC for 3GPP network domain. In a direct alternative example, at step 211a requestor 201 may send a management request or trigger message to domain management node 203. At step 211b, there may be a management action. At step 211c, domain management node 203 may send a message to requestor 201, the message may be a response, such as a response to the message of step 211a. Herein, although direct management requests or indirect management requests may be used for examples, it is contemplated the alternatives to the examples provided may be used.

The indirect alternative may rely upon specific SL servers being authorized or enabled to communicate with the management domain (e.g., EES in SA6 edge deployments). In an indirect alternative example, at step 212a, requestor 201 may send a management request or trigger message to SL server 202. At step 212b, SL server 202 may send (e.g., forward) the message of step 212a to domain management node 203. At step 212c, there may be a management action. At step 212d, domain management node 203 may send a message to SL server 201, the message may be a response, such as a response to the message of step 212b. At step 212e, requestor 201 may receive a message, which may be a response associated with the message of step 212a.

The following is a non-exhaustive list of management operations to be used in this context: provisioning, server lifecycle management (e.g., instantiation, termination), network or service slice profile change request, policy configuration or reconfiguration, etc.

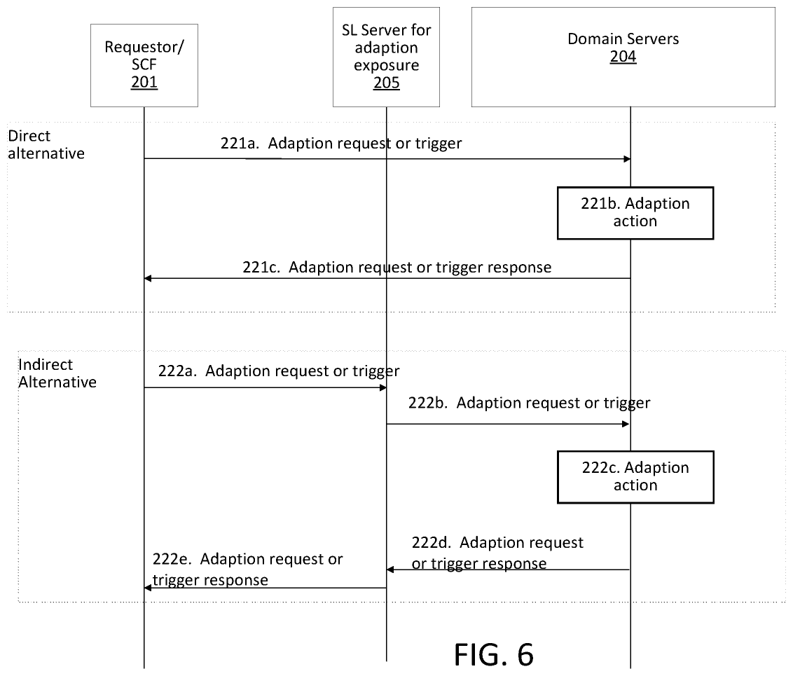

Service layer functionality may be enabled to execute slice adaption operations via third-party APIs. Slice adaption operations are generally performed by customizing functions, servers, etc. via direct interactions with the NFs in the CN and the servers in the service layer. An example of adaption operation to the CN may be the use of NEF APIs, such as AF influence on traffic routing, which can affect the corresponding slice. FIG. 6 shows direct and indirect alternatives for requesting or triggering adaption operations (in service or network domains) from a requestor in the service layer. FIG. 6 may include requester 201, SL server 205 for adaptation exposure (e.g., enabler server), or domain server 204. In a direct alternative example, at step 221a requestor 201 may send an adaptation request or trigger message to domain server 204. At step 221b, there may be a adaption action. At step 221c, domain server 204 may send a message to requestor 201, the message may be a response, such as a response to the message of step 221a.

The indirect alternative is more likely to apply for adaption requests to the network domain and relies upon specific SL servers being authorized or enabled to communicate with the 3GPP domain (e.g., enabler servers). In an indirect alternative example, at step 222a, requestor 201 may send a adaption request or trigger message to SL server 205. At step 222b, SL server 205 may send (e.g., forward) the message of step 222a to domain server 204. Domain server 204 may include an enabler, application servers for service domain, or NFs for 3GPP network domain. At step 222c, there may be a management action. At step 222d, domain server 204 may send a message to SL server 201, the message may be a response, such as a response to the message of step 222b. At step 222e, requestor 201 may receive a message, which may be a response associated with the message of step 222a.

Herein, although direct management requests or indirect methods (e.g., adaption operations or management requests) may be used for examples, it is contemplated the alternatives to the examples provided may be used.

Note that in some cases, management operations (e.g., server instantiation) may also be enabled to be executed via third-party APIs, e.g., using the service layer to directly request management operations from the management layer. It may depend on the SLA, level of abstraction of the deployed profiles, or APIs, etc. whether and how SCF coordination actions translate into slice lifecycle management or adaptions in anyone of the domains. For example, the SCF manage the two slice configurations and their mappings and triggers the instantiation of these configurations. Whether the underlying 3GPP network or the SL deployment allow for the SCF to fully manage their slices may depend on SLAs, abstraction levels used for 3^{rd} parties, etc.

The following is a non-exhaustive list of adaption operations that may be used in this context: provisioning or re-configuration of inter-connectivity, topology, or registration information; provisioning or re-configuration of fault supervision configuration; etc.

In some cases, operations may be performed or classified as management or adaption based on the business agreements between parties or deployment choices. A number of operations may be performed routinely for management or adaption, e.g., queries, subscriptions for event, measurements, performance assurance, some server re-configurations, etc.

Table 2 captures examples of the mapping maintained by SCF which may be for slice coordination corresponding to FIG. 4.

In Table 2, service configuration policies or network slice adaption policies may be SLA based, semi-static or pre-provisioned. Therefore, Table 2 information may be included in the mapping information. Disclosed herein are exemplary roles of service configuration, network configuration, or inter-domain configurations.

The configuration or mapping (e.g., configuration/mapping) maintained by SCF for each deployment it manages (e.g., coordinates) may refer to the relationships between the deployment service configuration (e.g., SrvS Profile or equivalent), the deployment network configuration (e.g., ANP or equivalent) or the inter-domain configurations for providing or optimizing services in the coordinated slice deployment. The coordination mapping may be a translation tool between service configuration or requirements in the service slice and network configuration or requirements in the network slice. SCF may augment the slice-specific information (e.g., the parameters in SrvS Profile or ANP) with inter-domain configurations to provide its coordination function.

TABLE 2
SCF-maintained coordination mapping example

| | | | | | Network |
|---|---|---|---|---|---|
| | | | | Service | slice |
| | Service | Network | Inter-domain | configuration | adaption |
| Deployment | configuration | configuration | configurations | policies | policies |
| Configuration/ | SrvS | ANP NS A | List of | Policy based | Policy |
| mapping I | Profile | | pre-existing | on SLA, | based on |
| | SrvS-1 | | or already | restricting | SLA, |
| | | | performed | SrvS-1 | restricting |
| | | | associations | configurations | NS A |
| | | | between | or operations | configurations |
| | | | SrvS-1 and | allowed at SCF | or |
| | | | ANP NS A | | operations |
| | | | | | allowed at |
| | | | | | ACF |
| Configuration/ | SrvS | ANP NS A | List of pre-existing | Policy based | Policy |
| mapping II | Profile | | or already performed | on SLA, | based on |
| | SrvS-2 | | associations between | restricting | SLA, |
| | | | SrvS-2 and ANP NS A | SrvS-2 | restricting |
| | | | | configurations | NS A |
| | | | | or operations | configurations |
| | | | | allowed at SCF | or |
| | | | | | operations |
| | | | | | allowed at |
| | | | | | ACF |
| Configuration/ | SrvS | ANP NS B | List of pre-existing | Policy based | Policy |
| mapping III | Profile | | or already performed | on SLA, | based on |
| | SrvS-2 | | associations between | restricting | SLA, |
| | | | SrvS-2 and ANP NS B | SrvS-2 | restricting |
| | | | | configurations | NS B |
| | | | | or operations | configurations |
| | | | | allowed at SCF | or |
| | | | | | operations |
| | | | | | allowed at |
| | | | | | ACF |
| Configuration/ | SrvS | ANP NS C | List of pre-existing | Policy based | Policy |
| mapping IV | Profile | | or already performed | on SLA, | based on |
| | SrvS-3 | | associations between | restricting | SLA, |
| | | | SrvS-3 and ANP NS C | SrvS-3 | restricting |
| | | | | configurations | NS C |
| | | | | or operations | configurations |
| | | | | allowed at SCF | or |
| | | | | | operations |
| | | | | | allowed at |
| | | | | | ACF |

Examples of inter-domain configurations which may be maintained for an edge deployment may include: EAS connection information, EAS Topological Service Area, EAS Geographical Service Area, Geographical Service Area, UPF selection requirements for AS/EASs, application/AF QoS requirements, N6 traffic routing requirements, or URSP rules, among others. This information may be maintained or managed in a variety of logical associations, such as: 1) URSP rules organized per UE, network slice, topological or geographical area, or application/AF; 2) UPF information (e.g., IP address, DNAI) organized by data network, configured SMF, NS serviceProfile or ANP, corresponding AF/EAS, or service area; or 3) ECS information (e.g., ECS address) organized by ECS provider identifier, PLMNs and slices in which ECS may be discovered via 5GS, or EESs which may be enabled to be registered to the ECS.

The following is an example deployment which may correspond to Table 2 and FIG. 4, using 3GPP SA6 service terminology. For example, a service provider provides service layer capabilities for a V2X service (S1) and for a factory service (S2). Assuming the S1 and S2 services are deployed in the same region, the SP may provide enablement for edge functionality using the same EDN, e.g., EESs or general-purpose EASs. The SP may secure SLAs with an MNO for several network slices, as shown in FIG. 4.

The SP may use SrvS-1 and NS A for the V2X enabler and application-specific servers, SrvS-3, and NS C for the FFApp enabler and application-specific servers and may use SrvS-2 for the edge servers. Although SrvS-2 deployment is used for both S1 and S2 services, not all of its nodes (e.g., servers) need to be in active use in both services. The servers in SrvS-2 may use NS A or NS B in the underlying network, depending on requirements for the supported services, e.g., S1 and S2. If both network slices are used, e.g., NS A for V2X UEs and NS B for FFApp UEs, the four configurations (e.g., mappings) detailed in Table 2 may be maintained to provide services.

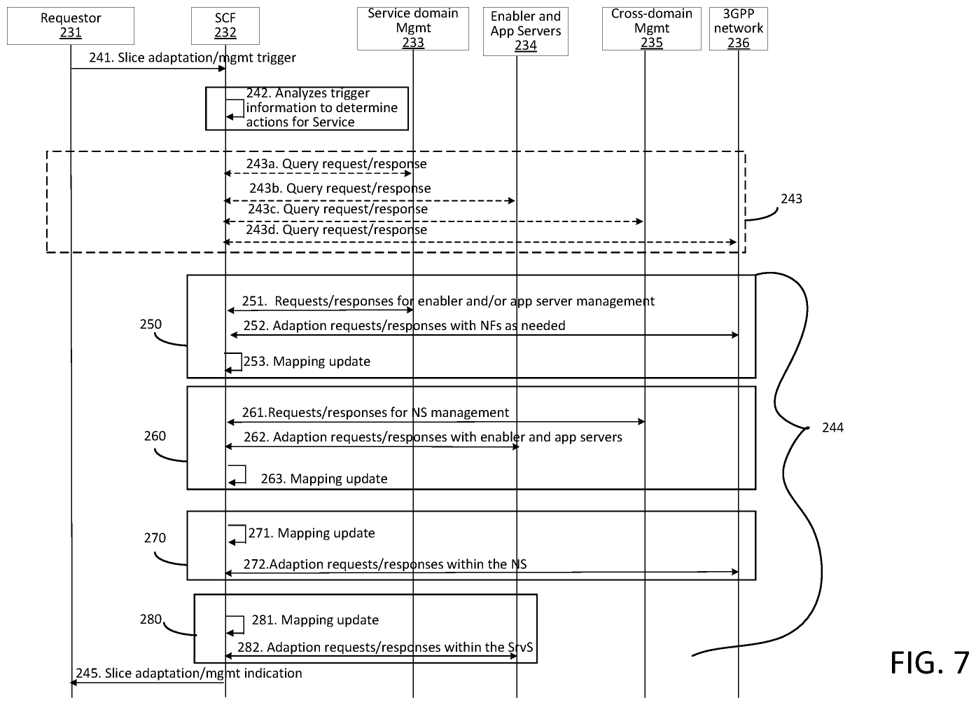

FIG. 7 provides an exemplary flow for that may be coordinated by slice adaption procedure executed by SCF, in order to coordinate the service configuration (e.g., based on SrvS Profile or equivalent), network configuration (e.g., ANP or equivalent), or the inter-domain configuration (e.g., mapping) of the deployment. FIG. 7 includes a plurality of nodes, such as requestor 231 (e.g., servers or clients), SCF 232, service domain management 233 (e.g., ASP, SP, or ECSP), enabler and app servers 234, cross-domain management 235 (e.g., MNO, NSP, or NSC), or network 236 (e.g., 3GPP network or network functions).

First, the flow description is generic, e.g., independent of technology deployed, detailing a broader range of possible actions. An SA6 embodiment is used herein as an example to some of the steps initially described generically.

The SCF 232 may be provisioned with policies based on SLA(s) for using management functionality in the 3GPP cross domain management 235, e.g., management of network slices in CN or radio access network (RAN). For example, the SCF 232 may consume services provided by MnS as described in 3GPP TS 23.533.

Similarly, SCF 232 may be provisioned with SLA(s) for using management functionality in the service domain, e.g., management of service slices. These policies may be pre-provisioned at SCF 232 by a deployment configuration server, may be provided during an initialization or registration step, may be signaled by VAL or enabler servers, may be retrieved by SCF 232 from the 3GPP network or the service layer management system, etc.

SCF 232 may receive (which may include retrieve or derive) the SrvS profile or slice profile of the NS being managed. SCF 232 may receive the SrvS profile or the NS profile from one or more deployment configuration servers, from VAL or enabler servers, from the 3GPP network or the service layer management systems, etc. The SrvS Profile and the NS profile may also be provided during an initialization or registration step. The SrvS Profile or the NS profile may be derived from the SLA-based policies pre-configured.

At step 241 of FIG. 7, SCF 232 may receive a slice adaption or management trigger from a requestor 231. Requestor 231 may be various entities in the service domain such as enabler nodes (e.g., EESs, VAE Servers, SEAL Servers) or application nodes (e.g., EAS, V2X application specific servers, VAL Servers). The trigger may be received from service domain clients. For example, if SCF 232 is realized to include an NSCE server, the trigger may be generated by an NSCE client. The trigger may be an explicit request for slice adaption or management, or may be implicitly provided, for example by a notification.

At step 242 of FIG. 7, SCF 232 may analyze the trigger information to determine the slice adaptation or management requirements and the corresponding actions necessary in the service or 3GPP domains. The actions that may be determined by SCF 232 may ultimately be implemented by the management systems in the respective domains. However, the pre-established SLAs for each of the domains may determine or limit the types of actions which SCF 232 may request.

At step 243 of FIG. 7, SCF 232 may trigger queries to determine additional information necessary to perform the determined actions. The queries may be performed prior to step 242 of FIG. 7, or as part of step 242 of FIG. 7 to obtain additional context information to make the step 242 determination.

SCF 232 may query the servers with management functionality in the service domain (step 243a of FIG. 7) or those for 3GPP cross-domain management (step 243c of FIG. 7). These queries may help determine the context or configurations of the slices in the respective domains, e.g., SrvS and NS.

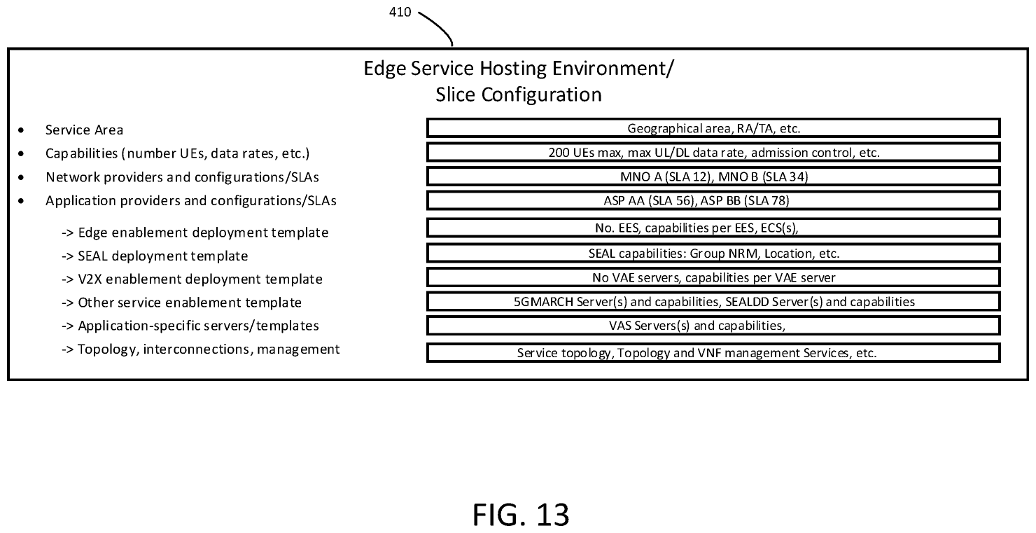

Service domain management servers 233 may be servers deployed by stakeholders, such as ASP, SP, or ECSP, which may manage service slice deployment or configuration, e.g., EESs, SEAL servers, or NSCE servers. Service domain management queries may be exposed as a GUI for management purposes, e.g., FIG. 13.

3GPP cross domain management servers 235 may be any servers deployed by stakeholders, such as MNO, NSP, or NSC, which may manage network slice (e.g., CN or RAN) deployments or configurations. For simplicity, such servers 235 may be termed MnS servers 235 deployed by MNO for the remainder of this document, but other implementations or deployments apply as well.

SCF 232 may query servers in the service domain (step 243b of FIG. 7) or 3GPP network (step 243d of FIG. 7). These queries may also help determine context or parameters for the slices in the respective domains.

Step 244 of FIG. 7 may include one or more blocks (including steps) of block 250 (e.g., SrvS management), block 260 (e.g., NS management), block 270 (e.g., mapping or NS adaptation), or block 280 (e.g., mapping or SrvS adaptation). SCF 232 may execute the actions determined in step 242 of FIG. 7. Several logical alternatives are described herein, however different implementations or use cases may result in executing a combination of the alternatives.

At a first alternative of step 244 (e.g., block 250), SCF 232 may determine that SrvS management is necessary to fulfill the requirements determined in step 242 of FIG. 7. NS adaption or mapping updates may be executed in association with re-alignment of configurations.

In step 251 (e.g., alternative associated with block 250) of FIG. 7, SCF 232 may request the corresponding service domain management server 233 to perform the management action, e.g., to instantiate a new server in SrvS. Step 252 of FIG. 7, SCF 232 may send requests for adaption to the NS, e.g., for N6 traffic routing requirements for the newly deployed server. SCF 232 includes any new or updated NS configuration information from NFs 236 in the 3GPP network. The requests in step 251 of FIG. 7 or step 252 of FIG. 7 may use parameters provided to SCF 232 via the step 241 request (e.g., SrvS Profile of Table 1), other requests or pre-provisioning (e.g., ANS) or from the step 243 of FIG. 7 query responses.

In step 253 of FIG. 7, SCF 232 may update the mapping information between the SrvS and NS as needed, based on the management actions or information. These sub-steps may include the receipt of corresponding responses. Depending on the adaption, step 243 of FIG. 7 may occur prior to step 242 of FIG. 7.

Step 244 of FIG. 7 may include an alternative as described in block 260. SCF 232 may determine that NS may be used to fulfill the requirements determined in step 242 of FIG. 7. SrvS adaption or mapping updates may be executed if necessary for re-alignment of configurations.

In block 260 at step 261, SCF 232 Slice adaption operations MnS server 235 to perform the management action, e.g., to instantiate a new NF in the NS, or to deploy a new NS. In step 262, SCF 232 may send requests for adaption to the SrvS, e.g., providing information about a newly deployed NS to be used by servers in SrvS. SCF 232 may receive new or updated SrvS configuration information from the servers (e.g., enabler or app servers 234) in the SrvS. The requests in step 261 or step 262 may use parameters provided to SCF 232 via the step 241 request (e.g., SrvS Profile of Table 1), other requests or pre-provisioning (e.g., ANS) or from step 243 of FIG. 7 query responses. In step 263 of FIG. 7, SCF 232 may update the mapping information between the SrvS and NS as needed, based on the management actions and information. These sub-steps may include the receipt of corresponding responses. Depending on the adaption required, step 263 of FIG. 7 may occur prior to step 262 of FIG. 7.

Step 244 of FIG. 7 includes alternative of block 270, in which SCF 232 may determine NS adaption is sufficient to fulfill the requirements determined in step 242 of FIG. 7 and sends a corresponding request, e.g., using NEF APIs. The request uses parameters provided to SCF 232 via step 241 of FIG. 7 request (e.g., SrvS Profile of Table 1), other requests or pre-provisioning (e.g., ANS) or from the step 243 of FIG. 7 query responses. Depending on the NS adaption requested, the mapping between NS and SrvS may need to be updated, before or after the NS adaption. This alternative may be considered a sub-case of alternative associated with block 250, without SrvS management action. At step 271 there may be mapping update. At step 272 there may be an adaption request (or response) with the NS associated with NF 236.

At step 244 of FIG. 7 may include alternative of block 280, in which SCF 232 may determine that SrvS adaption is sufficient to fulfill the requirements determined in step 242 of FIG. 7 and sends a corresponding request e.g., request an application server to register with an enabler server 234. The request uses parameters provided to the SCF via the step 241 of FIG. 7 request (e.g., SrvS Profile of Table 1), other requests or pre-provisioning (e.g., ANS) or from the step 243 of FIG. 7 query responses. Depending on the NS adaption requested, the mapping between NS and SrvS may need to be updated, before or after the NS adaption. This alternative may be considered a sub-case of alternative associated with step 260. At step 281 there may be mapping update. At step 282 there may be an adaption request (or response) communicating with enabler 234.

At step 245, SCF 232 provides an indication or response message to the step 241 of FIG. 7 requestor server or client.

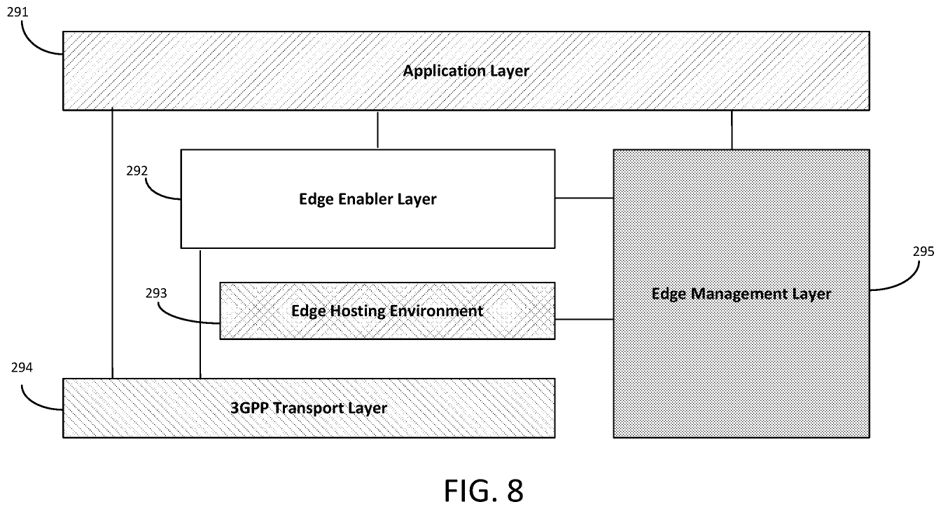

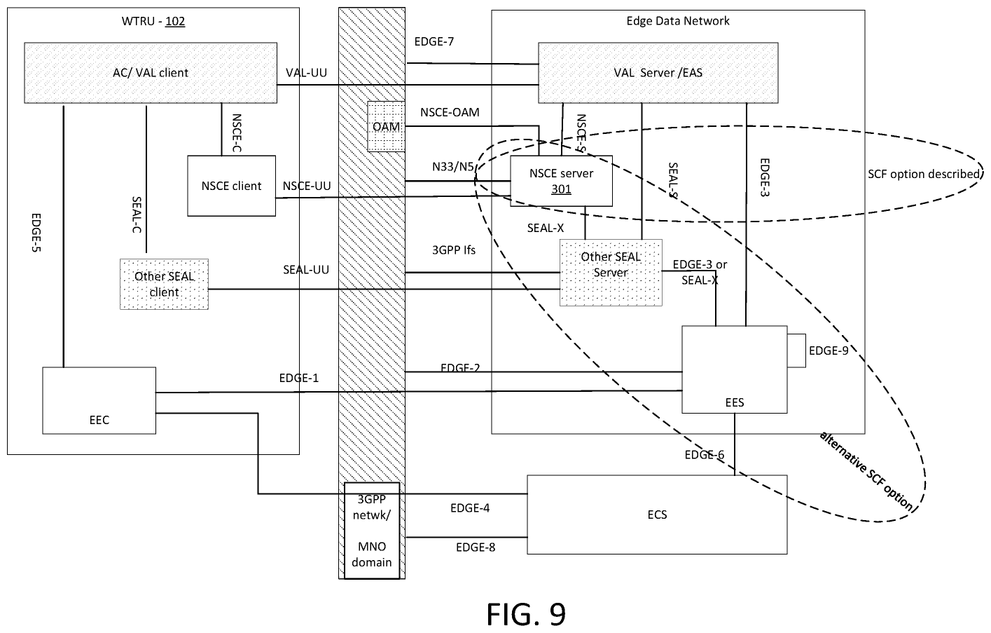

FIG. 8 provides an overview of 3GPP edge computing. This model may include application layer 291, edge enabler layer 292, edge hosting environment 293, 3GPP transport layer 294, or edge management layer 295. Based on the model of FIG. 8, an exemplary SA6 embodiment of an edge deployment is shown in FIG. 9. The SCF function integrates edge hosting environment management and network slice management functionality. as such, SCF 232 may have numerous implementation options relative to SA6 specifications, such as: within NSCE (SCF example further detailed herein); integrating EEL, NSCE and other SEAL functionality, such as NRM (alternative SCF option); or others.

Note the edge hosting environment and the corresponding network slice being managed by SCF 232 in this type of deployment may be termed slice hosting environment (SHE), or particularly as edge slice hosting environment (E-SHE).

FIG. 9 is a simplified representation of an SA6 Edge deployment. In one option, SCF may be implemented as a function of the NSCE Server. The following description uses an assumption of NSCE server managing a single NS and SrvS at a time within an edge deployment, but the method applies for other cardinalities.

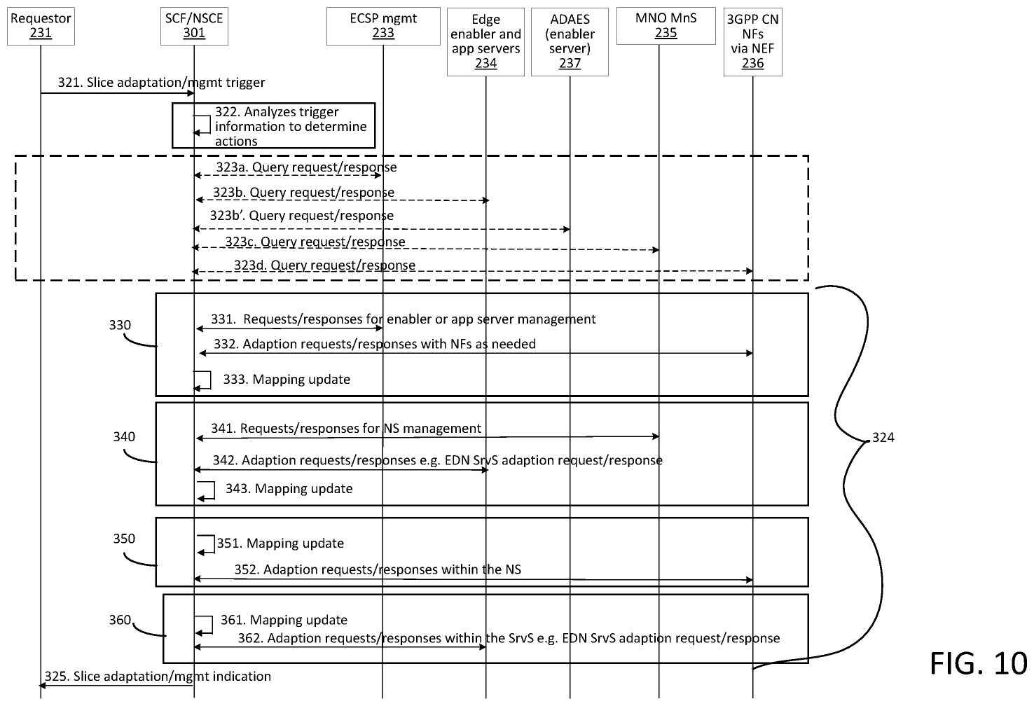

For this embodiment, the coordinated slice adaption flow introduced in FIG. 7 may be implemented as shown in FIG. 10 and described below. Examples of operations which may be performed within each step are provided. Given that many of the steps introduced describe alternatives, this flow is not meant to exemplify a single overall use case, rather it introduces a broad range of implementations of the options enabled by the disclosure.

The NSCE server 301 (as SCF 232) may be provisioned with configuration and management rules (e.g., based on SLAs) for managing the E-SHE. This may include separate configurations for edge hosting environment management (e.g., via SLA with ECSP) and network slice MnS management (e.g., via SLA with MNO). As a result of this pre-configuration, the SCF/NSCE server receives (or can retrieve or derive) the SrvS profile and slice profile of the NS being managed. The SCF/NSCE server 301 may receive the SrvS profile and the NS profile from one or more deployment configuration servers, from VAL or enabler servers, from the 3GPP network or the service layer management systems, etc. The SrvS profile and the NS profile may also be provided during an initialization or registration step.

In one example, the SCF/NSCE server 301 may be configured to provide mapping and harmonization services between the SrvS, NS, or other devices disclosed herein used by the edge deployment. In the same deployment, one or more EESs in the deployment may be configured to trigger instantiation of EASs, and therefore update the SrvS profile. The SCF/NSCE server 301 may be configured to receive notifications from the MNO-deployed MnS system for network slice status e.g., to monitor the slice load based on analytics, etc.

At step 321 of FIG. 10, SCF/NSCE server 301 may receive a slice adaption or management trigger from a requestor 231.

The request may be for an NSCE functionality, such as NS slice creation, NS allocation for a specific service, for automatic application layer network slice lifecycle management, etc. The request may be any SCF/NSCE explicit request, including subscriptions, notifications, etc. Such requests may be provided by applications in the edge deployment, e.g., EAS/VAL Servers.

This step 321 may also be initiated by a management trigger, which may be provided by other service layer servers or clients, and which affect SrvS configuration. For example, a management trigger may be received from an EES (e.g., edge enabler 234) when performing EAS lifecycle procedures, triggering server scaling or configuration procedures, etc. A management trigger may also be an EAS capability notification, QoS degradation, etc. A management trigger may also be received from 5GS/OAM system, e.g., number of UEs per slice threshold being reached, etc. or may be presented as LCM operations, such as modifyNsi/AllocateNsi/DeallocateNsi.

The request or trigger message received in step 321 may include any parameter from the SrvS Profile as listed in Table 1 or those corresponding to NS service profile/ANP. The request or trigger message may include any parameter from Table 3 or Table 5. It is to be noted that in step 323, the SCF/NSCE server 301 may trigger queries to determine additional information necessary to perform the necessary management actions. Therefore, step 321 of FIG. 10 information may be obtained instead via queries in step 323 of FIG. 10. The information provided in step 321 of FIG. 10 may be used with step 323 of FIG. 10 information and pre-provisioned information in the step 322 of FIG. 10 analysis, as well as to derive the parameters necessary for the messages exchanged in the following steps.

The step 321 of FIG. 10 requestors may be comprised of various entities in the service domain such as: enabler servers (e.g., EESs, VAE Servers, SEAL Servers), application servers (e.g., EAS, V2X application specific servers, VAL Servers). The trigger may also be received from service domain clients. For example, if SCF is realized to include an NSCE 301 server, the trigger may be generated by an NSCE client (not shown). The trigger may be an explicit request for slice adaption or management, or may be implicitly provided, for example by a notification.

Step 322 of FIG. 10. SCF/NSCE server may analyze the trigger information to determine the actions necessary in the service domain or network domain (e.g., 3GPP network). The actions that may be determined by the SCF will ultimately be implemented by the management systems in the respective domains. However, the pre-established SLAs for each of the domains may determine or limit the types of actions which the SCF may request.

Step 323 of FIG. 10. The SCF/NSCE server 301 may trigger queries to determine additional information necessary to perform the determined actions. The queries may also be performed prior to step 322 of FIG. 10, or as part of step 322 of FIG. 10. The queries may provide some of the information detailed in Table 1, so the information does not need be provided as part of a single message or from a single entity.

In the step 323a of FIG. 10 in an example where the EHE is implemented via ETSI MEC with SCF/NSCE server 301 as MEC Platform Manager (MECP-M), the query may be performed over the Mm3 reference point to an MEC orchestrator (e.g., as may be found in MEC platform specifications), retrieving status of the deployed services in service layer.

In the step 323b of FIG. 10 in an example, the SCF/NSCE server 301 may query one or more LESs 234 in the edge deployment or an ECS to determine the edge topology, as shown in the following Table 3.

TABLE 3
EES topology and metrics discovery request

| Information element | Description |
|---|---|
| SrvS Profile or SrvS | SrvS profile available at the EES, which may be part of the |
| Profile ID | SrvS profile for the deployment managed by SCF. This |
| | information may be an alternative to topology information |
| | provided via separate parameters in the following information |
| | elements. |
| EES topology | Information about the topology maintained or controlled by the |
| information | EES, in addition of the registered EASs. For example, historical |
| | information about EASs instantiated or deactivated, |
| | measurements maintained for EAS lifecycle management, |
| | number, and types of EASs instantiated based on EEC request, |
| | etc. |
| EAS discovery filters | Characteristics to determine EASs registered to the EES to be |
| | discovered, e.g. EAS ID, EAS state (active/inactive), EAS |
| | capabilities, EAS profile. |
| Location | Provides an area/location the query is limited to. May be |
| | provided as geographical area, RA/TA, target DNAI |
| EAS metadata | Context and metadata available at the EES for each of the |
| | discovered/registered EASs. For example, information about |
| | the average or min/max load levels over time, the actual area |
| | the connected UEs 300 covered, measured server availability, |
| | response time, etc. |
| Registered EECs | EES statistics on EECs being provided services by the EES. |
| | The information may be provided as averages over time, |
| | min/max UEs within a period, instantaneous measurements, etc. |
| | The information may also be broken down by EASs with which |
| | ACs being managed by the EEC communicate or services they |
| | registered for, etc. The information may include number of |
| | EEC, average amount of time being provided with service by |
| | EES or its EASs, UE locations while receiving services, UE |
| | capabilities, |
| Traffic characteristics | Information about the traffic the EES manages directly or |
| | indirectly in the deployment, e.g., data rates, QoS, etc. as |
| | determined by the EES. This information may be provided per |
| | registered EAS, serviced EEC, etc. |
| ACR statistics | Statistics about the ACRs performed by or at the EES, which |
| | may include average time between ACRs, ACR trigger |
| | statistics, ACR planning information, statistics derived about |
| | the associated ACTs, etc. |

In the step 323b′ of FIG. 10 alternative, the SCF/NSCE Server 301 may query another enabler server 237. e.g., ADAES for analytics related to with SrvS or NS. For example, query request/response may be EES topology and metrics discovery request or response, as in step 323b or 323b′. Table 4 is an example of the slices information request to ADAES. The information required and provided in this case may include actual measurements, related events, etc., as well as derived information or predictions.

TABLE 4
ADAES slice information request

| Information element | Description |
|---|---|
| UE information | Analytics regarding the UEs 300 connected to one or more NSs |
| | of interest. The information may be requested over a specific |
| | period of time, at a specific location, for a given provider, based |
| | on specific UE capabilities, etc. |
| Client information | Analytics regarding the service clients hosted on UEs 300 |
| | receiving services from one or more SrvS of interest. The |
| | information may be requested over a specific period of time, at |
| | a specific location, for a given provider, based on specific client |
| | type or capabilities, per contacted server, etc. |
| Location and mobility | Analytics related to the observed mobility of UE 300 or clients |
| information | using the services of the deployment. The information may be |
| | provided by indicating geographical/topological areas of min or |
| | max usage, trajectories, average speeds, etc. The information |
| | may be provided also using other mobility-related events or |
| | information, e.g., average numbers of handovers required, |
| | min/max number of ACR procedures over a period of time, etc. |
| Application QoS | Analytics tailored for different communication means (e.g., per |
| | access network, operator, etc.) The information may be |
| | provided per network server, e.g., to determine server |
| | performance or load. |
| Computing information | Analytics relating to computational resources and loads for the |
| | host platform for the enablement/service layer or for the 3GPP |
| | network. This information may be provided also as |
| | performance, failure, service availability, etc. metrics. |
| Network slice load or | Analytics obtained via ADAES from 5GS, from NWDAF (e.g., |
| performance analytics | slice load analytics) and MDAS (e.g., NSI/NSSI performance |
| | analytics). Analytics derived by ADAES from the 5GS data e.g. |
| | related to applications, mat be included. |
| Service slice analytics | Analytics relating to the service slice, such as the number of |
| | applications/users being supported by the service slice, |
| | coverage, load, etc. |
| API capability analytics | Service API and exposure API analytics such as rates of |
| | successful/failed API invocation, predicted API availability, |
| | information about the conditions under which the APIs are |
| | instantiated or by whom, etc. |

In a step 323c of FIG. 10 example a query for performance assurance measurements may be performed and end-to-end KPI measurements measured by MNO MnS or other network devices may be provided, as described in 3GPP SA5 specifications.

In a step 323d of FIG. 10 example the SCF/NSCE server 301 receives interacts with the 3GPP CN via NEF 236, e. Specifically, the SCF/NSCE server 301 may receive information from NWDAF via NEF, e.g., by subscribing to events such as “NSI_LOAD.” FIG. 10 provides a single block for the 3GPP CN 236. NEF may be the exposure or interface function, wherein interaction with the NFs in that box (including NWDAF) may go through NEF.

Step 324 of FIG. 10. SCF/NSCE server 301 may execute the slice management actions determined to be necessary to maintain the services and the slice mappings.

Step 324 of FIG. 10 may include an alternative which is associated with block 330 (e.g., SrvS management), SCF/NSCE server 301 may determine that SrvS management is necessary to fulfill the requirements determined in step 322. NS adaption and mapping updates are executed if necessary for re-alignment of configurations.

In step 331 of FIG. 10, SCF/NSCE server 301 may request the corresponding service domain management server 233 to perform the management action, e.g., to instantiate a new EES or a new SEAL server, to scale up an existing EES, etc. In step 332 of FIG. 10 the SCF/NSCE server 301 may send requests for adaption to the NS, e.g., for N6 traffic routing requirements for the newly deployed EES and SEAL server. In step 333 of FIG. 10. SCF/NSCE server 301 may update the mapping information between the SrvS and NS as needed, e.g., by updating the local coordination mapping and performing the EDN NF 5GC connection provisioning as detailed in 3GPP TS 23.538.

In step 324 of FIG. 10 may include an alternative which is associated with block 340 (e.g., NS management), SCF/NSCE server 301 may determine that NS management should be used to fulfill the requirements determined in step 322 of FIG. 10. SrvS adaption and mapping updates are executed if necessary for re-alignment of configurations.

In step 341 of FIG. 10 associated with block 340, SCF/NSCE server 301 requests the corresponding MnS server to perform the management action, e.g., to deploy new UPFs in the NS. In step 342 of FIG. 10 SCF/NSCE server 301 may send requests for SrvS adaption, e.g., providing information about the new UPFs to be used by EAS (e.g., edge enabler 234) in SrvS. SCF/NSCE server 301 also receives any new or updated SrvS configuration information from the servers in the SrvS. For example, in step 342 of FIG. 10 SCF/NSCE server 301 may send EDN SrvS adaption requests as detailed in Table 5. Such a request may be sent to one or more EESs (e.g., edge enabler 234) in the EDN, to affected EASs, etc.

In step 343 of FIG. 10, SCF/NSCE server 301 may update the mapping information between the SrvS and NS as needed, based on the management actions and information. These sub-steps may include the receipt of corresponding responses. Depending on the adaption required, step 343 of FIG. 10 may occur prior to step 342 of FIG. 10.

TABLE 5
EDN SrvS adaption request

| | |
|---|---|
| Information element | Description |

Topology adaption information

| | |
|---|---|
| Service slice location | Updated information on area/location serviced of the EDN. |
| adaption | May be provided as geographical area, RA/TA, target DNAI, |
| | etc. |
| List of EDN nodes | For each of the nodes in the topology maintained or controlled |
| | by the EES, zero or more of the following information may be |
| | provided for adaption: |
| >EAS Profile | EAS profile changes allowed to be determined by the SCF. For |
| | example, the List of N6 Traffic Routing requirements, List of |
| | EAS DNAI(s), EAS Geographical Service Area, EAS Service |
| | KPIs. etc. may change based on NS changes. |
| >ECS information | ECS information available at the EES for EES registration |
| | purposes. With NS changes, additional ECSs may become |
| | available, others may be de-prioritized, etc. similarly, |
| | information about the EDNs being serviced by an ECS may be |
| | re-configured. |
| >EES Profile | EES profile changes allowed to be determined by the SCF. For |
| | example, the List of EES DNAI(s), EES Geographical or |
| | Topological Service Area, etc. may change based on NS |
| | changes. |
| >Topology adaption per | Information about changes in the topology/relationship |
| exiting node | between nodes, requested for the purpose of the adaption. For |
| | example, the request may result in an EAS de-registering from |
| | one EES and registering to another. If this request is sent to |
| | EES, it may inform EES to deregister the EAS and provide |
| | cause/information directing registration to another EES. |
| | Alternatively, a transfer of registration EAS registration from |
| | one EES to another may be implemented. Topology adaption |
| | information may also be provided in a more abstract way, e.g., |
| | by providing criteria for EASs which should be registered to an |
| | EES. Based on this information, the EES may de-register EASs |
| | which do not conform, may implement EAS registration |
| | triggers to discovered EASs, etc. |
| | Another option is for adaption requests with SrvS topology |
| | adaption is for the requests to be targeting the nodes (e.g., EAS) |
| | instead of, or in addition to, the topology management node |
| | (e.g., EES.) |
| >Node configuration | Modified configuration information for the node, e.g., |
| adaption | measurements to be maintained for each server's lifecycle |
| | management, etc. |

Capability adaption information

| | |
|---|---|
| Service enablement | List of updated parameters or characteristics per enabler |
| capabilities adaption | supported (e.g., SEAL, Edgeapp, V2XApp), e.g., list of types |
| | supported, min and max number of enablement servers of the |
| | same type to be deployed, etc. |
| Service application | List of updated parameters per application supported, e.g., min |
| capabilities adaption | and max number of application servers of the same type to be |
| | deployed, application provider IDs, etc. |
| Service slice | Updated information about the management functionality |
| management adaption | available at the slice, including SLAs per provider, management |
| | APIs, etc. |
| Traffic characteristic | Updated information about the traffic characteristics in |
| adaption | the deployment, e.g., data rates, QoS, etc. |
| Network exposure | Updated information about the type and capabilities of the |
| adaption | network exposure APIs available. |
| CAPIF adaption | Updated information about CAPIF support and the CAPIF |
| | deployment to be used, e.g., CCF contact information, etc. |
| Service slice enablement | List of enablement services (e.g., as EASID) provided by the |
| services list | service slice. The list may include additional parameters or |
| | characteristics per enabler (e.g., SEAL, Edgeapp, V2XApp), |
| | e.g., min and max number of enablement servers of the same |
| | type to be deployed, etc. |

KPIs and constraints information

| | |
|---|---|
| KPIs and constraints | Updated information on service characteristics and constraints |
| adaption | of the service slice/EDN. This information may be used to |
| | determine the necessary adaption operations. Updates may be |
| | provided to any of the components of the “KPIs and constraint” |
| | information elements in Table 1 |

Step 324 of FIG. 10 may include an alternative which is associated with block 350 (e.g., mapping or NS adaptation), SCF/NSCE server 301 determines that NS adaption is sufficient to fulfill the requirements determined in step 322 of FIG. 10. For example, SCF/NSCE server 301 may determine that an UPF may need to be included in the SMF configuration for an MNO-deployed EES. The mapping between NS and SrvS may need to be updated to reflect UPF serving the EES. FIG. 10 include step 351 for a mapping update. At step 352, there may be adaption requests/responses within the NS.

Step 324 of FIG. 10 may include an alternative, which is associated with block 360, SCF/NSCE server 301 may determine that mapping updates or SrvS adaption are sufficient to fulfill the requirements determined in step 322 of FIG. 10. For example, /NSCE may determine that based on NS changes an EAS (e.g., edge enabler 234) needs to use another exiting UPF and the SrvS profile needs to be modified for a lower number of UEs supported. NSCE 301 updates the EAS information and the number of UEs 300 supported in the SrvS accordingly. For example, EDN SrvS adaption request as detailed in Table 5 may be used. FIG. 10 includes step 361, which may be a mapping update. At step 362, there may be an adaption communication (e.g., request or responses) within the SrvS (e.g., EDN SrvS adaption request/response).

In step 325 of FIG. 10, SCF/NSCE server 301 provides an indication or response to the step 321 of FIG. 10 requestor servers or clients.

SCF may be used (e.g., by edge service providers) for coordination when an edge deployment is instantiated or configured. In this role, SCF complements functionality implemented at EESs (e.g., dynamic EAS instantiation, traffic influence with the N6 routing information of EASs) and the NS configuration or adaption functionality at NSCE, to deploy or configure Slice Hosting Environment (SHE), e.g., an edge hosting environment (EHE) and the corresponding network slice (NS). Two deployment examples are described herein.

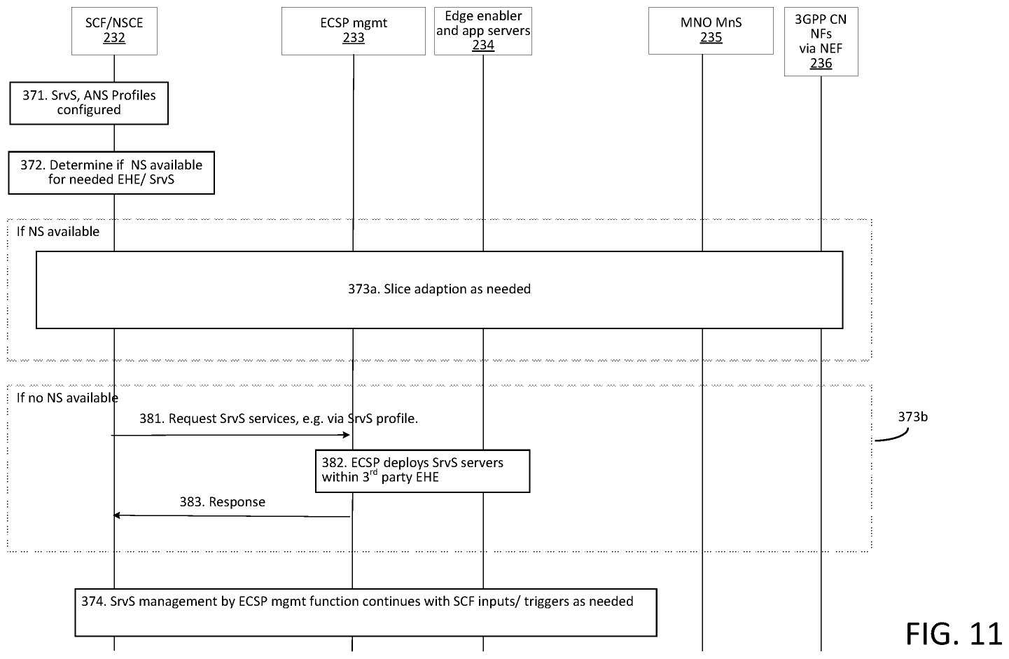

In a first deployment type, the ECSP may be a third party and service domain management (e.g., ECSP management) is separate from PLMN management. FIG. 11 illustrates exemplary SCF actions for enabling the instantiation or deployment of an EHE in the generic case in which ECSP management and MNO MnS are separate.

In step 371 of FIG. 11, the SrvS profile at SCF 232 may be preconfigured. Therefore, EHE configuration is known. The pre-configuration may be provided or managed by ECSP management node 233 (also referred herein as service domain management server 232 or ETSI MEC). Service domain management node may be associated with an ASP, SP, or ECSP. SCF 232 may be provided with an abstracted profile of the NSs available for configuration, e.g., based on the SLAs between ECSP management node 233 and MNO 235.

In step 372 of FIG. 11, based on pre-provisioned ANP, network SLA, or configured SrvS profile, SCF 232 may determine whether there are available NSs meeting the service requirements of the service slice. SCF 232 may make this determination based on the service SLAs, network SLAs, requirement translation, or possible queries as described in step 323 of the Example SA6 SCF coordinated slice adaption above in FIG. 10.

With reference to block 373a, if SCF 232 determines that there are available NSs to support services in the given SrvS profile, SCF 232 may proceed in step 373a of FIG. 11 to create a mapping between the two slices. For example, SCF 232 may query 5G system (5GS) to determine the necessary information (e.g., UPF, PCF. NEF information), and may configure the corresponding service entities (e.g., NS to SrvS mapping). Step 373a of FIG. 11 (e.g., step 324 of FIG. 10) of the slice adaption procedure previously described in FIG. 10 (e.g., block 330, block 340, block 350, or block 360) may be performed as needed for slice adaption.

With reference to block 373b, if in step 372 SCF 232 determines that there are no available NSs, SCF 232 may request the necessary SrvS services from ECSP management node 233 and coordinates EHE deployment with NS deployment. With reference to block 373b, in step 381 of FIG. 11, SCF may provide the SrvS profile of the edge deployment to the edge management function so that ECS, EESs, etc., are identified or instantiated. SCF 232 may interact with the EESs (e.g., edge enabler 233) or the edge management function to trigger the instantiation of the initial EASs to be deployed in the EHE. In step 382 of FIG. 11 ECSP management node 233 may deploy the SrvS servers within the 3^{rd} part EHE. In step 383 of FIG. 11 a response may be provided to SCF 232.

Following these actions, as shown in step 374 of FIG. 11, SrvS management by ECSP management function may continue with SCF inputs or triggers as needed.

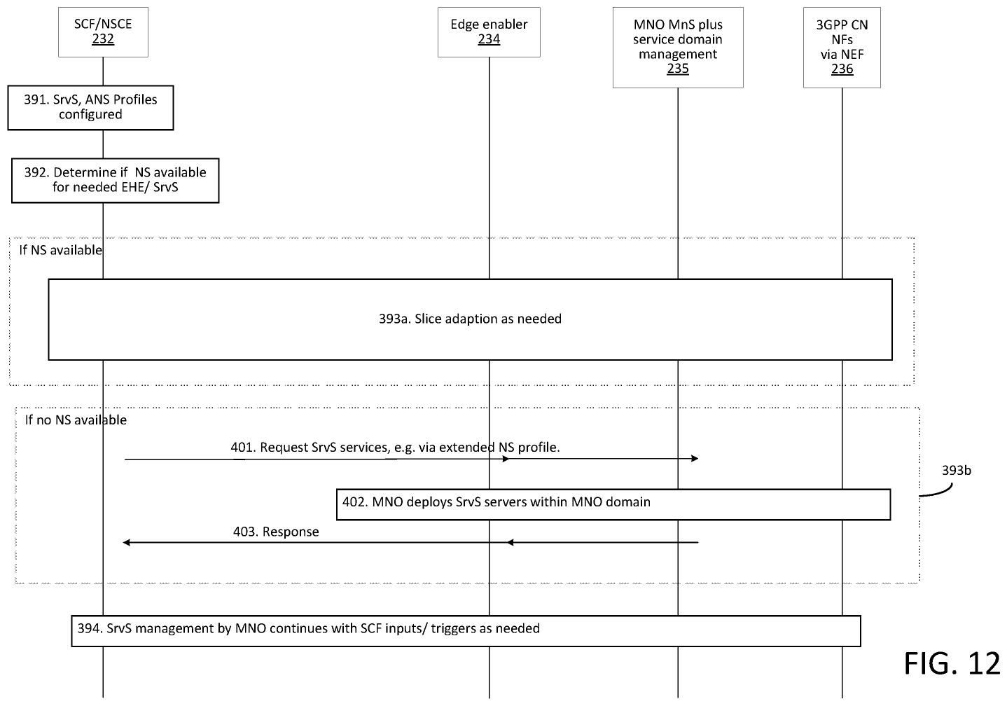

In a second deployment type, PLMN management may be used to deploy SrvS servers within its domain. In this case MNO may deploy all or some SrvS servers within an EHE as network functions. FIG. 12 illustrates exemplary SCF actions for enabling the initiation or deployment of an EHE when MNO MnS is co-located with the service domain management.

In step 391 of FIG. 12 the ECSP management node 233 may pre-configure the SrvS profile at SCF 232, which may make the EHE configuration known. SCF 232 may be then provided with an abstracted profile of the NSs available for configuration, e.g., based on the SLAs between ECSP management node 233 and MNO.

In step 391 of FIG. 12, based on pre-provisioned ANP, network SLA, or the configured SrvS profile, SCF 232 may determine whether there are available NSs meeting the service requirements of the service slice. SCF 232 may make this determination based on the service SLAs, network SLAs, requirement translation, or possible queries as described in step 323 of FIG. 10 of the Example SA6 SCF coordinated slice adaption above.

With reference to block 393a, if in step 392 of FIG. 12, SCF 232 determines that there are available NSs to support services in the given SrvS profile, SCF 232 may proceed in step 393a of FIG. 12 to create a mapping between the two slices. For example, SCF 232 may query 5GS to determine the necessary information (e.g., UPF, PCF, NEF information), and may configure the corresponding service entities (e.g., NS to SrvS mapping). IN step 393 of FIG. 12, the slice adaption procedure previously described in FIG. 10 (e.g., block 330, block 340, block 350, or block 360) may be performed as needed for slice adaption.

With reference to block 393b, if in step 392 above SCF 232 determines that there are no available NSs, SCF 232 may request the necessary SrvS services from the MNO (e.g., MNO 235). In step 401 of FIG. 12, SCF 232 may provide the SrvS profile to the PLMN management, e.g., via an extended NS profile. Based on step 401, the PLMN management may deploy the SrvS servers within the MNO domain. In step 402 of FIG. 12, MNO MnS 235, for example, may deploy the SrvS servers within the MNO domain. In step 403 of FIG. 12 a response may be provided to SCF 232. FIG. 12 shows that in this deployment, SCF 232 management requests/responses may be indirect, e.g., performed via enablement entities, such as EES, NSCE, etc.

Following these actions, as shown in step 394 of FIG. 12, SrvS management by the MNO MnS 235 may continue with SCF inputs or SCF triggers, as needed.

Information may be collected from the ECSP for configuring and managing an edge deployment. FIG. 13 shows an example of edge deployment information that may be entered via a graphical user interface 410 of an ECSP.

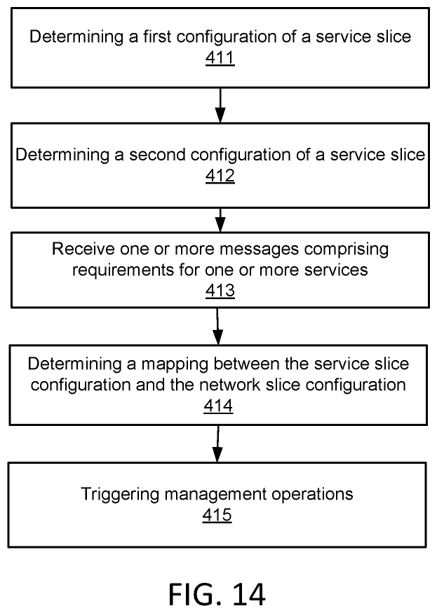

FIG. 14 illustrates an exemplary method associated with service slice coordination as disclosed herein.

At step 411, determining a first configuration of a service slice. The service slice may be associated with a service layer. The first configuration may be determined based on pre-provisioned information or information of one or more messages from a first apparatus.

At step 412, determining a second configuration of a network slice in a network. The network may be a 3GPP network. The second configuration may be determined based on pre-provisioned information or information of one or more messages from a second apparatus.

At step 413, receiving one or more messages comprising requirements for one or more services. The one or more service may be from the group of services (e.g., NF service set).

At step 414, determining a mapping between the service configuration and the network slice configuration. The mapping between the service configuration and network slice configuration based on the first configuration of the service slice, the second configuration of the network slice, and the received service requirements.

At step 415, triggering one or more management operations. The one or more management operations may be triggered based on the mapping, which may be derived in the service layer, the application, or network (e.g., 3GPP). Note that there may be multiples levels of management, such as ECSP 233 management or MNO 235 management. SCF 232 may send requests” or “triggering.” What gets executed upon request or triggering may be actions such as adaptations or management operations. Management operations may include operations executed by ECSP 233 or MNO 235.

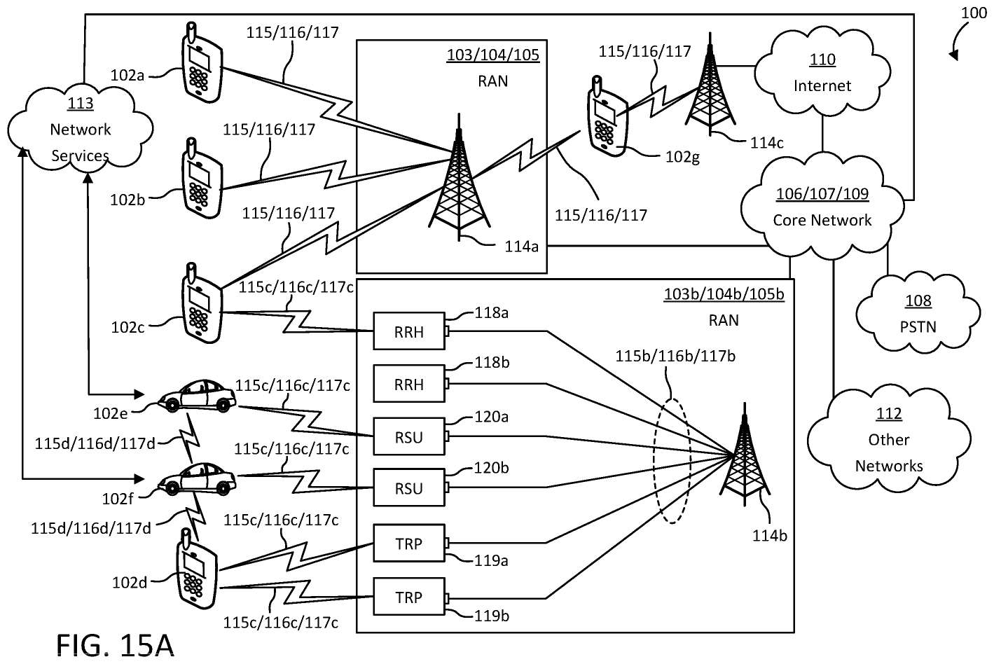

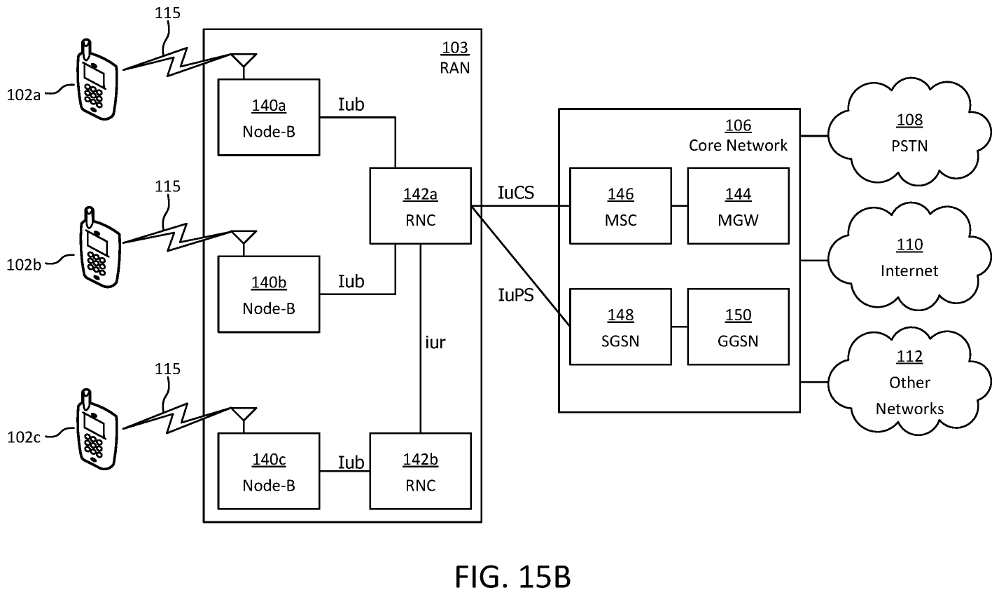

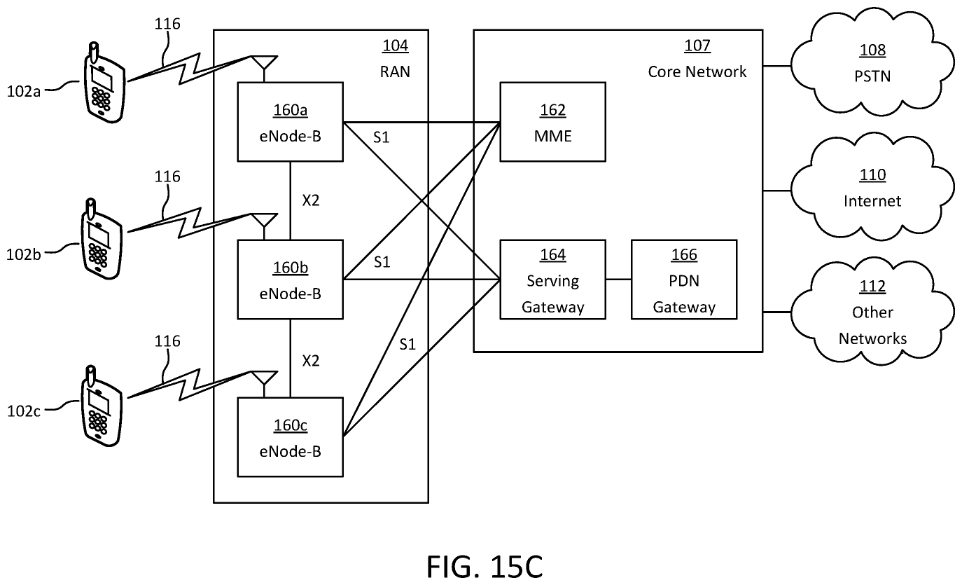

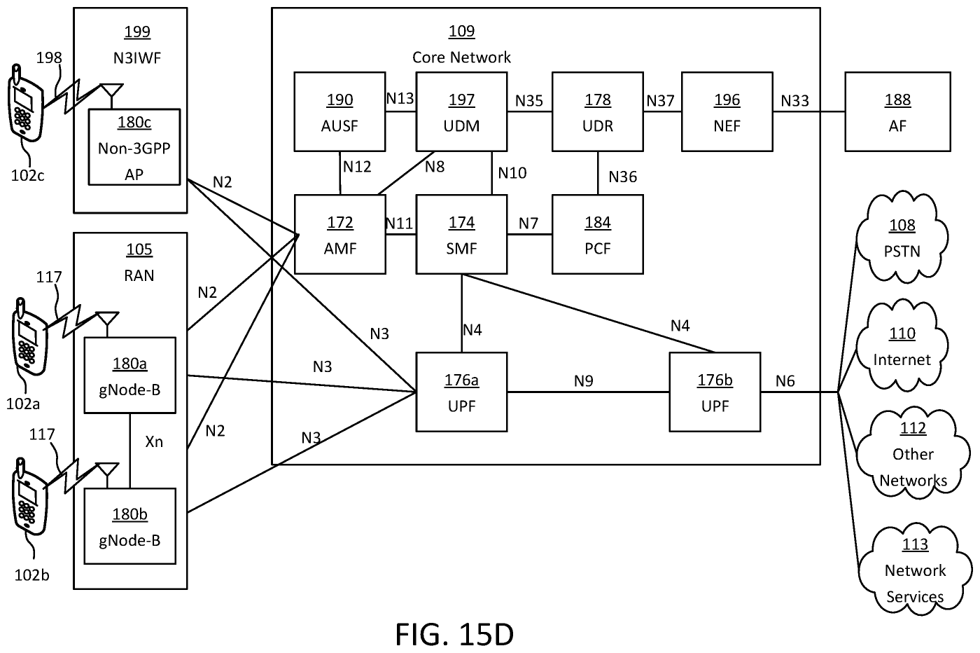

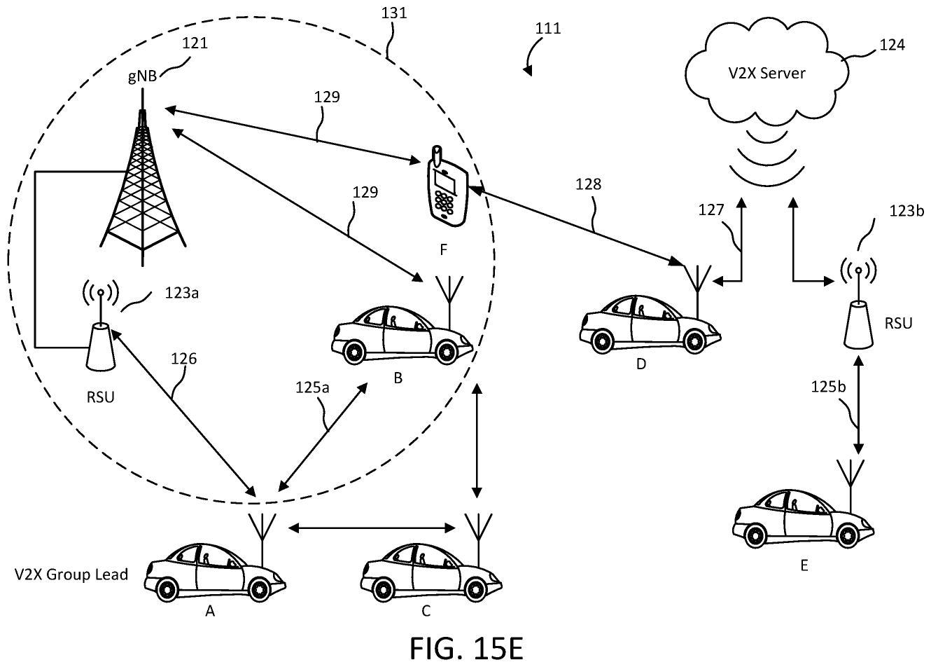

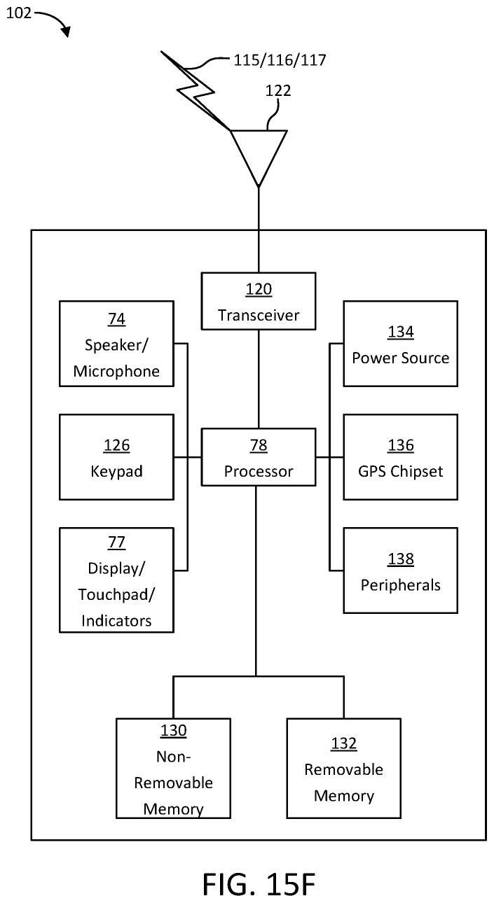

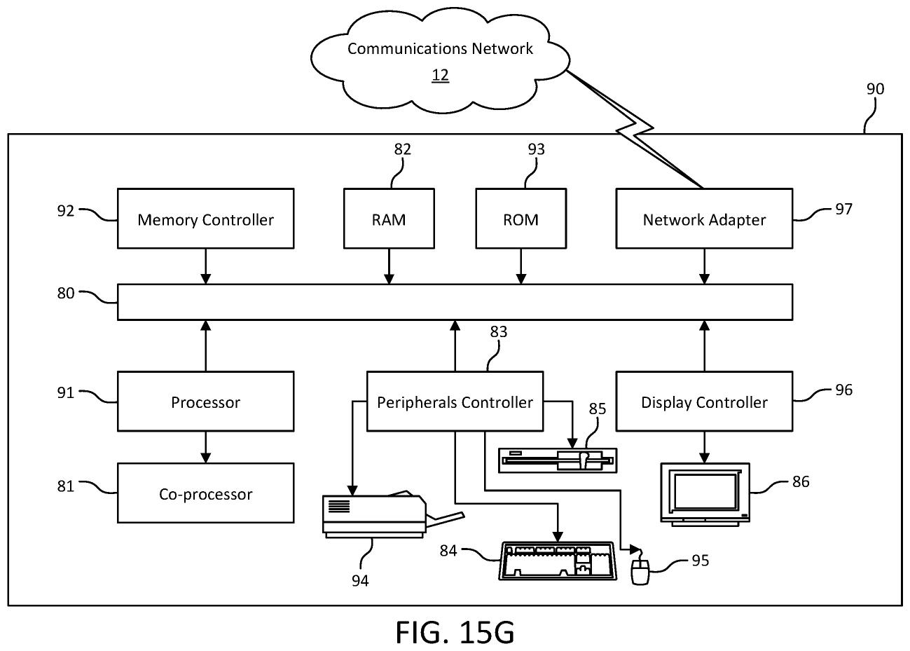

It is understood that the entities performing the steps illustrated herein, such as FIG. 4-FIG. 14, may be logical entities. The steps may be stored in a memory of, and executing on a processor of, a device, server, or computer system such as those illustrated in FIG. 15F or FIG. 15G. Skipping steps, combining steps, or adding steps between exemplary methods disclosed herein (e.g., associated with FIG. 4-FIG. 14) is contemplated.

Below, including Table 6, provides abbreviations and exemplary definitions for the subject matter disclosed herein. The following definitions are used in the context of the disclosed subject matter.

Edge Hosting Environment: An environment providing support required for edge application server's execution

Network Slice: A logical network that provides specific network capabilities and network characteristics; supporting various service properties for network slice customers.

Network Slice instance: A set of network function instances and the required resources (e.g., compute, storage, and networking resources) which form a deployed network slice.

NSI ID: an identifier for identifying the core network part of a network slice instance when multiple network slice instances of the same network slice are deployed, and there is a need to differentiate between them in the 5GC.

NF instance: an identifiable instance of the NF.

NF service instance: an identifiable instance of the NF service.

NF Service Set: A group of interchangeable NF service instances of the same service type within an NF instance. The NF service instances in the same NF Service Set have access to the same context data.

NF Set: A group of interchangeable NF instances of the same type, supporting the same services and the same Network Slice(s). The NF instances in the same NF Set may be geographically distributed but have access to the same context data.

Service level specification (SLS): a set of service level requirements associated with a service level agreement (SLA) to be satisfied by a network slice.

The following terminology associated with SP or SrvS are newly disclosed or clarified in the context herein.

Service providers (SP) is used generally to include communication service providers, edge computing service providers, application service providers, etc. The services may be provided to service customers (SCs) and may be of various categories, e.g., edge computing services, access to vertical applications, etc. service providers may be customers of the 5GS services provided by the network operators.

Service Slice: a logical application service environment including services with specific service characteristics satisfying various attribute requirements or application deployments for service providers or customers. Customers herein may be users and may particularly refer to the devices associated with respective users.

TABLE 6
Abbreviations and Definitions

| Abbreviations | Definitions |
|---|---|
| 3GPP | Third Generation Partnership Project |
| 5GS | 5G System |
| ADAES | Application Data Analytics Enablement Server |
| AF | Application Function |
| API | Application Programming Interface |
| AS | Application Server |
| CN | Core Network |
| DN | Data Network |
| EAS | Edge Application Server |
| EEC | Edge Enabler Client |
| EES | Edge Enabler Server |
| ECS | Edge Configuration Server |
| ECSP | Edge computing Service Provider |
| GUI | Graphical User Interface |
| KPI | Key Performance Indicator |
| LCM | Life Cycle Management (3GPP SA5) |
| MNO | Mobile Network Operator |
| MnS | Management System (3GPP SA5) |
| NEF | Network Exposure Function |
| NF | Network Function |
| NS | Network Slice |
| NSC | Network Slice Customer |
| NSCE | Network Slice Capability Exposure |
| NSI | Network Slice Instance |
| NSP | Network Slice Provider |
| NSSAI | Network Slice Selection Assistance Information |
| OAM | Operations, Administration and Maintenance |
| PCF | Policy Control Function |
| PLMN | Public Land Mobile Network |
| QoE | Quality of Experience |
| QoS | Quality of Service |
| SCF | Slice Configuration Function |
| SEAL | Service Enabler Architecture Layer for Verticals |
| SLA | Service Level Agreement |
| SP | Service Provider |
| UE | User Equipment |
| URSP | UE Route Selection Policy |
| VAL | Vertical Application Layer |

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to include a new, non-backwards compatible radio access in new spectrum below 6 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), Non-Terrestrial Networks (NTN), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

FIG. 15A illustrates an example communications system 100 in which the methods and apparatuses of service slice coordination for edge deployments, such as the systems and methods illustrated in FIG. 4 through FIG. 14 described and claimed herein may be used. The communications system 100 may include wireless transmit/receive units (WTRUs) 102a, 102b, 102c, 102d, 102e, 102f, or 102g (which generally or collectively may be referred to as WTRU 102 or WTRUs 102). The communications system 100 may include, a radio access network (RAN) 103/104/105/103b/104b/105b, a core network 106/107/109, a public switched telephone network (PSTN) 108, the Internet 110, other networks 112, and Network Services 113. Network Services 113 may include, for example, a V2X server, V2X functions, a ProSe server, ProSe functions, IoT services, video streaming, or edge computing, etc.

It will be appreciated that the concepts disclosed herein may be used with any number of WTRUs, base stations, networks, or network elements. Each of the WTRUs 102a, 102b, 102c, 102d, 102e, 102f, or 102g may be any type of apparatus or device configured to operate or communicate in a wireless environment. Although each WTRU 102a, 102b, 102c, 102d, 102e, 102f, or 102g may be depicted in FIG. 15A, FIG. 15B, FIG. 15C, FIG. 15D, FIG. 15E, or FIG. 15F as a hand-held wireless communications apparatus, it is understood that with the wide variety of use cases contemplated for 5G wireless communications, each WTRU may comprise or be embodied in any type of apparatus or device configured to transmit or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus, truck, train, or airplane, and the like.

The communications system 100 may also include a base station 114a and a base station 114b. In the example of FIG. 15A, each base stations 114a and 114b is depicted as a single element. In practice, the base stations 114a and 114b may include any number of interconnected base stations or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, or the other networks 112. Similarly, base station 114b may be any type of device configured to wiredly or wirelessly interface with at least one of the Remote Radio Heads (RRHs) 118a, 118b, Transmission and Reception Points (TRPs) 119a, 119b, or Roadside Units (RSUs) 120a and 120b to facilitate access to one or more communication networks, such as the core network 106/107/109, the Internet 110, other networks 112, or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, or other networks 112

TRPs 119a, 119b may be any type of device configured to wirelessly interface with at least one of the WTRU 102d, to facilitate access to one or more communication networks, such as the core network 106/107/109, the Internet 110, Network Services 113, or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations or network elements (not shown), such as a Base Station Controller (BSC), a Radio Network Controller (RNC), relay nodes, etc. Similarly, the base station 114b may be part of the RAN 103b/104b/105b, which may also include other base stations or network elements (not shown), such as a BSC, a RNC, relay nodes, etc. The base station 114a may be configured to transmit or receive wireless signals within a particular geographic region, which may be referred to as a cell (not shown). Similarly, the base station 114b may be configured to transmit or receive wired or wireless signals within a particular geographic region, which may be referred to as a cell (not shown) for methods, systems, and devices of service slice coordination for edge deployments, as disclosed herein. Similarly, the base station 114b may be configured to transmit or receive wired or wireless signals within a particular geographic region, which may be referred to as a cell (not shown). The cell may further be divided into cell sectors. For example, the cell associated with the base station 114a may be divided into three sectors. Thus, in an example, the base station 114a may include three transceivers, e.g., one for each sector of the cell. In an example, the base station 114a may employ multiple-input multiple output (MIMO) technology and, therefore, may utilize multiple transceivers for each sector of the cell.

The base stations 114a may communicate with one or more of the WTRUs 102a, 102b, 102c, or 102g over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, or RSUs 120a, 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c,102d, 102e, or 102f may communicate with one another over an air interface 115d/116d/117d, such as Sidelink communication, which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) or Evolved HSPA (HSPA+). HSPA may include High-Speed Downlink Packet Access (HSDPA) or High-Speed Uplink Packet Access (HSUPA).

In an example, the base station 114a and the WTRUs 102a, 102b, 102c, or RRHs 118a, 118b, TRPs 119a, 119b, or RSUs 120a, 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) or LTE-Advanced (LTE-A). In the future, the air interface 115/116/117 or 115c/116c/117c may implement 3GPP NR technology. The LTE and LTE-A technology may include LTE D2D and V2X technologies and interfaces (such as Sidelink communications, etc.). Similarly, the 3GPP NR technology includes NR V2X technologies and interface (such as Sidelink communications, etc.).

The base station 114a in the RAN 103/104/105 and the WTRUs 102a, 102b, 102c, and 102g or RRHs 118a, 118b, TRPs 119a, 119b or RSUs 120a, 120b in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 15A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like, for implementing the methods, systems, and devices of service slice coordination for edge deployments, as disclosed herein. In an example, the base station 114c and the WTRUs 102, e.g., WTRU 102e, may implement a radio technology such as IEEE 802.11 to establish a wireless local area network (WLAN). similarly, the base station 114c and the WTRUs 102d, may implement a radio technology such as IEEE 802.15 to establish a wireless personal area network (WPAN). In yet another example, the base station 114c and the WTRUs 102, e.g., WTRU 102e, may utilize a cellular-based RAT (e.g., WCDMA, CDMA2000, GSM, LTE, LTE-A, NR, etc.) to establish a picocell or femtocell. As shown in FIG. 15A, the base station 114c may have a direct connection to the Internet 110. Thus, the base station 114c may not be required to access the Internet 110 via the core network 106/107/109.

The RAN 103/104/105 or RAN 103b/104b/105b may be in communication with the core network 106/107/109, which may be any type of network configured to provide voice, data, messaging, authorization and authentication, applications, or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, packet data network connectivity, Ethernet connectivity, video distribution, etc., or perform high-level security functions, such as user authentication.

Although not shown in FIG. 15A, it will be appreciated that the RAN 103/104/105 or RAN 103b/104b/105b or the core network 106/107/109 may be in direct or indirect communication with other RANs that employ the same RAT as the RAN 103/104/105 or RAN 103b/104b/105b or a different RAT. For example, in addition to being connected to the RAN 103/104/105 or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102a, 102b, 102c, 102d, 102e to access the PSTN 108, the Internet 110, or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned or operated by other service providers. For example, the networks 112 may include any type of packet data network (e.g., an IEEE 802.3 Ethernet network) or another core network connected to one or more RANs, which may employ the same RAT as the RAN 103/104/105 or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links for implementing methods, systems, and devices of service slice coordination for edge deployments, as disclosed herein. For example, the WTRU 102g shown in FIG. 15A may be configured to communicate with the base station 114a, which may employ a cellular-based radio technology, and with the base station 114c, which may employ an IEEE 802 radio technology.

Although not shown in FIG. 15A, it will be appreciated that a User Equipment may make a wired connection to a gateway. The gateway maybe a Residential Gateway (RG). The RG may provide connectivity to a Core Network 106/107/109. It will be appreciated that much of the subject matter included herein may equally apply to UEs that are WTRUs and UEs that use a wired connection to connect with a network. For example, the subject matter that applies to the wireless interfaces 115, 116, 117 and 115c/116c/117c may equally apply to a wired connection.

FIG. 15B is a system diagram of an example RAN 103 and core network 106 that may implement methods, systems, and devices of service slice coordination for edge deployments, as disclosed herein. As noted above, the RAN 103 may employ a UTRA radio technology to communicate with the WTRUs 102a, 102b, and 102c over the air interface 115. The RAN 103 may also be in communication with the core network 106. As shown in FIG. 15B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 15B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 15B may include a media gateway (MGW) 144, a Mobile Switching Center (MSC) 146, a Serving GPRS Support Node (SGSN) 148, or a Gateway GPRS Support Node (GGSN) 150. While each of the foregoing elements are depicted as part of the core network 106, it will be appreciated that any one of these elements may be owned or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned or operated by other service providers.

FIG. 15C is a system diagram of an example RAN 104 and core network 107 that may implement methods, systems, and devices of service slice coordination for edge deployment, as disclosed herein. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink or downlink, and the like. As shown in FIG. 15C, the eNode-Bs 160a, 160b, and 160c may communicate with one another over an X2 interface.

The core network 107 shown in FIG. 15C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned or operated by other service providers.

FIG. 15D is a system diagram of an example RAN 105 and core network 109 that may implement methods, systems, and devices of service slice coordination for edge deployments, as disclosed herein. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink or downlink, and the like. As shown in FIG. 15D, the gNode-Bs 180a and 180b may communicate with one another over an Xn interface, for example.

The core network 109 shown in FIG. 15D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless or network communications or a computer system, such as system 90 illustrated in FIG. 15G.

In the example of FIG. 15D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3TWF) 199, a User Data Repository (UDR) 178. While each of the foregoing elements are depicted as part of the 5G core network 109, it will be appreciated that any one of these elements may be owned or operated by an entity other than the core network operator. It will also be appreciated that a 5G core network may not include all of these elements, may include additional elements, and may include multiple instances of each of these elements. FIG. 15D shows that network functions directly connect with one another, however, it should be appreciated that they may communicate via routing agents such as a diameter routing agent or message buses.

In the example of FIG. 15D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 15D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 15D. The PCF 184 may provide policy rules to control plane nodes such as the AMF 172 and SMF 174, allowing the control plane nodes to enforce these rules. The PCF 184 may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect with network functions, so that network function can add to, read from, and modify the data that is in the repository. For example, the UDR 178 may connect with the PCF 184 via an N36 interface. Similarly, the UDR 178 may connect with the NEF 196 via an N37 interface, and the UDR 178 may connect with the UDM 197 via an N35 interface.

The UDM 197 may serve as an interface between the UDR 178 and other network functions. The UDM 197 may authorize network functions to access of the UDR 178. For example, the UDM 197 may connect with the AMF 172 via an N8 interface, the UDM 197 may connect with the SMF 174 via an N10 interface. Similarly, the UDM 197 may connect with the AUSF 190 via an N13 interface. The UDR 178 and UDM 197 may be tightly integrated.

The AUSF 190 performs authentication related operations and connect with the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect with an AF 188 via an N33 interface and it may connect with other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 15D, in a network slicing scenario, a WTRU 102a, 102b, or 102c may connect with an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned or operated by other service providers.

The core network entities described herein and illustrated in FIG. 15A, FIG. 15C, FIG. 15D, or FIG. 15E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIG. 15A, FIG. 15B, FIG. 15C, FIG. 15D, or FIG. 15E are provided by way of example only, and it is understood that the subject matter disclosed and claimed herein may be embodied or implemented in any similar communication system, whether presently defined or defined in the future.

FIG. 15E illustrates an example communications system 111 in which the systems, methods, apparatuses that implement service slice coordination for edge deployments, described herein, may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 15E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 15E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 15F is a block diagram of an example apparatus or device WTRU 102 that may be configured for wireless communications and operations in accordance with the systems, methods, and apparatuses that implement service slice coordination for edge deployments, described herein, such as a WTRU 102 of FIG. 15A, FIG. 15B, FIG. 15C, FIG. 15D, or FIG. 15E, or FIG. 10. As shown in FIG. 15F, the example WTRU 102 may include a processor 78, a transceiver 120, a transmit/receive element 122, a speaker/microphone 74, a keypad 126, a display/touchpad/indicators 77, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 15F and may be an exemplary implementation that performs the disclosed systems and methods for service slice coordination for edge deployments described herein.

The processor 78 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 78 may perform signal coding, data processing, power control, input/output processing, or any other functionality that enables the WTRU 102 to operate in a wireless environment. The processor 78 may be coupled to the transceiver 120, which may be coupled to the transmit/receive element 122. While FIG. 15F depicts the processor 78 and the transceiver 120 as separate components, it will be appreciated that the processor 78 and the transceiver 120 may be integrated together in an electronic package or chip.

The transmit/receive element 122 of a UE may be configured to transmit signals to, or receive signals from, a base station (e.g., the base station 114a of FIG. 15A) over the air interface 115/116/117 or another UE over the air interface 115d/116d/117d. For example, the transmit/receive element 122 may be an antenna configured to transmit or receive RF signals. The transmit/receive element 122 may be an emitter/detector configured to transmit or receive IR, UV, Radar, LIDAR, or visible light signals, for example. The transmit/receive element 122 may be configured to transmit and receive both RF and light signals. It will be appreciated that the transmit/receive element 122 may be configured to transmit or receive any combination of wireless or wired signals.

In addition, although the transmit/receive element 122 is depicted in FIG. 15F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 78 of the WTRU 102 may be coupled to, and may receive user input data from, the speaker/microphone 74, the keypad 126, or the display/touchpad/indicators 77 (e.g., a liquid crystal display (LCD) display unit or organic light-emitting diode (OLED) display unit. The processor 78 may also output user data to the speaker/microphone 74, the keypad 126, or the display/touchpad/indicators 77. In addition, the processor 78 may access information from, and store data in, any type of suitable memory, such as the non-removable memory 130 or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 78 may access information from, and store data in, memory that is not physically located on the WTRU 102, such as on a server that is hosted in the cloud or in an edge computing platform or in a home computer (not shown). The processor 78 may be configured to control lighting patterns, images, or colors on the display or indicators 77 in response to whether the setup of the service slice coordination for in some of the examples described herein are successful or unsuccessful, or otherwise indicate a status of service slice coordination for edge deployments and associated components. The control lighting patterns, images, or colors on the display or indicators 77 may be reflective of the status of any of the method flows or components in the FIG.'s illustrated or discussed herein (e.g., FIG. 4-FIG. 14, etc). Disclosed herein are messages and procedures of service slice coordination for edge deployments. The messages and procedures may be extended to provide interface/API for users to request resources via an input source (e.g., speaker/microphone 74, keypad 126, or display/touchpad/indicators 77) and request, configure, or query service slice coordination for edge deployments related information, among other things that may be displayed on display 77.

The processor 78 may receive power from the power source 134 and may be configured to distribute or control the power to the other components in the WTRU 102. The power source 134 may be any suitable device for powering the WTRU 102. For example, the power source 134 may include one or more dry cell batteries, solar cells, fuel cells, and the like.

The processor 78 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) or determine its location based on the timing of the signals being received from two or more nearby base stations. It will be appreciated that the WTRU 102 may acquire location information by way of any suitable location-determination method.

The processor 78 may further be coupled to other peripherals 138, which may include one or more software or hardware modules that provide additional features, functionality, or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth®module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect with other components, modules, or systems of such apparatuses or devices via one or more interconnect interfaces, such as an interconnect interface that may comprise one of the peripherals 138.

FIG. 15G is a block diagram of an exemplary computing system 90 in which one or more apparatuses of the communications networks illustrated in FIG. 15A, FIG. 15C, FIG. 15D and FIG. 15E as well as service slice coordination for edge deployments, such as the systems and methods illustrated in FIG. 4 through FIG. 14 described and claimed herein may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs). Field Programmable Gate Array (FPGAs) circuits, any other type of integrated circuit (IC), a state machine, and the like. The processor 91 may perform signal coding, data processing, power control, input/output processing, or any other functionality that enables the computing system 90 to operate in a communications network. Coprocessor 81 is an optional processor, distinct from main processor 91, that may perform additional functions or assist processor 91. Processor 91 or coprocessor 81 may receive, generate, and process data related to the methods and apparatuses disclosed herein for service slice coordination for edge deployments.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally include stored data that cannot easily be modified. Data stored in RAM 82 may be read or changed by processor 91 or other hardware devices. Access to RAM 82 or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may include peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may include communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIG. 15A, FIG. 15B, FIG. 15C, FIG. 15D, or FIG. 15E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 78 or 91, cause the processor to perform or implement the systems, methods and processes described herein. Specifically, any of the steps, operations, or functions described herein may be implemented in the form of such computer executable instructions, executing on the processor of an apparatus or computing system configured for wireless or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

In describing preferred methods, systems, or apparatuses of the subject matter of the present disclosure—service slice coordination for edge deployments—as illustrated in the Figures, specific terminology is employed for the sake of clarity. The claimed subject matter, however, is not intended to be limited to the specific terminology so selected.

The various techniques described herein may be implemented in connection with hardware, firmware, software or, where appropriate, combinations thereof. Such hardware, firmware, and software may reside in apparatuses located at various nodes of a communication network. The apparatuses may operate singly or in combination with each other to effectuate the methods described herein. As used herein, the terms “apparatus,” “network apparatus,” “node,” “device,” “network node,” or the like may be used interchangeably. In addition, the use of the word “or” is generally used inclusively unless otherwise provided herein (e.g., as in step 391).

This written description uses examples for the disclosed subject matter, including the best mode, and also to enable any person skilled in the art to practice the disclosed subject matter, including making and using any devices or systems and performing any incorporated methods. The disclosed subject matter may include other examples that occur to those skilled in the art (e.g., skipping steps, combining steps, or adding steps between exemplary methods disclosed herein).

Methods, systems, and apparatuses, among other things, as described herein may provide for service slice coordination for edge deployments. A method, system, computer readable storage medium, or apparatus for determining (which may include receiving), based on pre-provisioned information, or based on one or more messages from a first apparatus, a first configuration of a service slice in the service layer; determining (which may include receiving), based on pre-provisioned information, or based on one or more messages from a second apparatus, a second configuration of a network slice in the 3GPP network; receiving one or more messages comprising requirements for one or more of the services from the group of services; determining, based on the first configuration of a service slice, the second configuration of a network slice, and the received service requirements, a mapping between the service slice configuration or the network slice configuration; and triggering (e.g., executing or sending to a device to execute) management operations based on the derived mapping in the service layer, the application layer, or the 3GPP network. A method, system, computer readable storage medium, or apparatus for determining based on received service requirements to update the service slice configuration, the network slice configuration, or the mapping. A method, system, computer readable storage medium, or apparatus for triggering management operations to implement the slice configuration update determined. The apparatus may include a network application server or function. The service slice may include a set of application servers or functions. The service slice may include a set of application servers or functions deployed in an edge hosting environment. All combinations (including the removal or addition of steps) in this paragraph are contemplated in a manner that is consistent with the other portions of the detailed description.

What is claimed:

1. An apparatus associated with network or service slices supporting services, the apparatus comprising:
a processor; and
a memory coupled with the processor, the memory comprising executable instructions stored thereon that when executed by the processor cause the processor to effectuate operations comprising:
determining, based on first information, a first configuration of a service slice;
determining, based on second information, a second configuration of a network slice in a network;
receiving one or more messages, the one or more messages comprising requirements for one or more services;
based on the first configuration of the service slice, the second configuration of the network slice, and the requirements for the one or more services, determining a mapping between the first configuration of the service slice and the second configuration of the network slice; and
triggering a management operation, based on the mapping in a service layer, an application layer, or the network.

2. The apparatus of claim 1, wherein the service slice comprises a set of application servers or application functions.

3. The apparatus of claim 1, wherein the service slice comprises a set of application servers or application functions deployed in an edge hosting environment.

4. The apparatus of claim 1, wherein the first information comprises pre-provisioned information or one or more messages from a first apparatus.

5. The apparatus of claim 1, wherein the second information comprises pre-provisioned information or one or more messages from a second apparatus.

6. The apparatus of claim 1, the operations further comprising determining, based on received service requirements, to update the first configuration of the service slice, the second configuration of the network slice, or the mapping.

7. The apparatus of claim 6, the operations further comprising triggering management operations to implement the update of the first configuration of the service slice.

8. The apparatus of claim 1, wherein the network comprises a 3GPP network.

9. A method associated with network or service slices supporting services, the method comprising:
determining, based on first information, a first configuration of a service slice;
determining, based on second information, a second configuration of a network slice in a network;
receiving one or more messages, the one or more messages comprising requirements for one or more services;
based on the first configuration of the service slice, the second configuration of the network slice, and the requirements for the one or more services, determining a mapping between the first configuration of the service slice and the second configuration of the network slice; and
triggering a management operation, based on the mapping in a service layer, an application layer, or the network.

10. The method of claim 9, wherein the service slice comprises a set of application servers or application functions.

11. The method of claim 9, wherein the service slice comprises a set of application servers or application functions deployed in an edge hosting environment.

12. The method of claim 9, wherein the first information comprises pre-provisioned information or the one or more messages from a first apparatus.

13. The method of claim 9, wherein the second information comprises pre-provisioned information or the one or more messages from a second apparatus.

14. The method of claim 9, further comprising determining, based on received service requirements, to update the first configuration of the service slice, the second configuration of the network slice, or the mapping.

15. The method of claim 14, further comprising triggering management operations to implement the update of the first configuration of the service slice.

16. The method of claim 9, wherein the network comprises a 3GPP network.

17. A computer readable storage medium storing computer executable instructions that when executed by a computing device cause the computing device to effectuate operations comprising:
determining, based on first information, a first configuration of a service slice;
determining, based on second information, a second configuration of a network slice in a network;
receiving one or more messages, the one or more messages comprising requirements for one or more services;
based on the first configuration of the service slice, the second configuration of the network slice, and the requirements for the one or more services, determining a mapping between the first configuration of the service slice and the second configuration of the network slice; and
triggering a management operation, based on the mapping in a service layer, an application layer, or the network.

18. The computer readable storage medium storing of claim 17, wherein the service slice comprises a set of application servers or application functions.

19. The computer readable storage medium storing of claim 17, wherein the service slice comprises a set of application servers or application functions deployed in an edge hosting environment.

20. The computer readable storage medium storing of claim 17, the operations further comprising determining, based on received service requirements, to update the first configuration of the service slice, the second configuration of the network slice, or the mapping.
